(19) United States
(12) Patent Application Publication
(10) Pub. No.: US 2025/0357800 A1
(43) Pub. Date: Nov. 20, 2025

(54) METHOD FOR DETECTING THE RELATIVE POSITION OF A STATIONARY INDUCTION CHARGING DEVICE TO A MOBILE INDUCTION CHARGING DEVICE

(71) Applicant: MAHLE International GmbH, Stuttgart (DE)

(72) Inventor: Mike Boettigheimer, Kornwestheim (DE)

(21) Appl. No.: 18/854,542

(22) PCT Filed: Apr. 6, 2023
(86) PCT No.: PCT/EP2023/059097

§ 371 Date: Oct. 6, 2024

(30) Foreign Application Priority Data
Apr. 7, 2022 (DE) 10 2022 203 487.2

(51) Int. Cl. H02J 50/90; B60L 53/12; B60L 53/36; B60L 53/38; H02J 50/00; H02J 50/10

(52) U.S. Cl. CPC H02J 50/90; B60L 53/12; H02J 50/005; H02J 50/10; B60L 53/36; B60L 53/38

(57) ABSTRACT

A method for detecting the relative position of a stationary induction charging device to a mobile induction charging device may include generating, in one of the stationary induction charging device and the mobile induction charging device, at least two distinguishable fields each having an intensity maximum. The at least two fields may include an approach field and at least one further field. The method may further include receiving the at least two fields in the other induction charging device, determining an approach ratio between the approach field and the further field, and detecting that the mobile energy coil approaches the stationary energy coil transversely to the height direction when the determined approach ratio lies in a predetermined approach ratio range.

### CROSS-REFERENCE TO RELATED APPLICATIONS

This application claims priority to International Patent Application No. PCT/EP2023/059097, filed on Apr. 6, 2023, and German Patent Application No. DE 10 2022 203 487.2, filed on Apr. 7 2022, the contents of both of which are hereby incorporated by reference in their entirety.

### TECHNICAL FIELD

The present invention relates to a method for detecting the relative position of a stationary induction charging device to a mobile induction charging device, which interact with one another in a charging operation for inductive energy transfer. The invention also relates to a computer program product for carrying out said method, a system with a stationary induction charging device and a mobile induction charging device, which is operated according to the method, and a mobile application, in particular a motor vehicle, with a mobile induction charging device of such a system and a stationary induction charging device of such a system.

### BACKGROUND

A system for inductive energy transfer usually comprises a stationary induction charging device and a mobile induction charging device. In a charging operation, an energy coil of one of the induction charging devices acts as a primary coil and the energy coil of the other induction charging device acts as a secondary coil. Such systems are typically used for inductive energy transfer to a mobile application, for example to a motor vehicle, wherein the mobile application comprises the mobile induction charging device. In mobile applications, the energy coil of the mobile induction charging device is usually the secondary coil during charging operation. For inductive energy transfer, the primary coil generates an alternating magnetic field, which induces a voltage in the secondary coil. In order to make inductive energy transfer possible and to increase the efficiency of inductive energy transfer, the primary coil and the secondary coil and thus the energy coils of the induction charging devices must be positioned correspondingly relative to one another.

In EP 2 727 759 B1, a transmitter and a receiver are used to detect the relative position of a mobile induction charging device attached to a motor vehicle.

DE 10 2012 205 283 A1 proposes to use an even number of detector coil elements which are wound oppositely in pairs and form a detector pair.

EP 3 347 230 B1 proposes to use a transmitter unit in the mobile induction charging device which during operation emits a transmission signal of a predetermined frequency. The transmission signal with the predetermined frequency is received by a receiving unit and a signal part of the transmission signal is determined. Thus, on the basis of the identified signal part, a relative position is determined.

DE 10 2017 215 932 B3 describes a method for determining position information of a motor vehicle on a surface. The motor vehicle has a mobile induction charging device. By energizing the energy coil of the mobile induction charging device, at least one magnetic structure arranged in or on a surface over which the motor vehicle travels is magnetized. The structure is stored in a digital map together with a position indication of the relevant structure, whereby the position of the motor vehicle is identified on the basis of the magnetized structure.

### SUMMARY

The present invention relates to the object of providing improved or at least different embodiments for a method for detecting the relative position of a stationary induction charging device to a mobile induction charging device, for a computer program product for carrying out the method, for a system operated in this manner with a stationary induction charging device to a mobile induction charging device and a mobile application with a mobile induction charging device of such a system and for a stationary induction charging device of such a system, which in particular eliminate disadvantages of the prior art. In particular, the present invention relates to the object of providing improved or at least different embodiments for the method, for the computer program product, for the system, and for the mobile application and for the stationary induction charging device, which embodiments are characterized by increased precision and/or increased robustness of the detection of the relative positioning of the energy coils of the system.

This object is achieved according to the invention by the subject matter of the independent claim(s). Advantageous embodiments are the subject matter of the dependent claim(s).

The present invention is therefore based on the general idea of generating at least two fields in one of the induction charging devices that are fixed to the energy coil of the associated induction charging device in order to detect the relative position between energy coils of a stationary induction charging device and a mobile induction charging device of a system for inductive energy transfer, in particular to detect the approach of the energy coils, of which at least one is spaced transversely to a height direction from the associated energy coil, wherein the fields are received in the other induction charging device and an approach of the energy coils to one another transversely to the height direction is detected on the basis of a ratio between two of the received fields. Since ratios of the fields are used to detect the relative position of the energy coils to one another, the relative position can be determined more reliably and more easily, particularly in comparison to absolute values of the fields or runtime differences of at least one field. This is in particular due to the fact that the ratio of the received fields does not change or only changes slightly as the distance changes in the height direction. In this way, for example, mobile induction charging devices in associated applications can be installed or arranged at different heights and/or stationary induction charging devices can be installed or arranged at different heights or depths and the position of the energy coils relative to one another can still be detected without further calibration. Consequently, an approach of the two energy coils to one another is detected in a simple and effective manner.

As explained, using the ratio to detect the position of the energy coils relative to one another has in particular the advantage that repeated calibration of induction charging devices that inductively transfer energy to one another can be dispensed with. This means that at least one ratio can be predetermined in advance, wherein when determining such a ratio from the received fields it is detected that there is a corresponding position of the energy coils relative to one another. In this manner, it is possible in particular to transfer said predetermined ratios either from the induction charging device generating the fields to the receiving induction charging device once, preferably before the positioning starts, in order to determine the position of the energy coils relative to one another. Alternatively and preferably, the ratios are fixed so that the predetermined ratio is stored in the receiving induction charging device and thus no transmission to the receiving induction charging device is necessary. In particular, this allows the relative position between energy coils of different stationary induction charging devices and different mobile induction charging devices to be determined in a simple and robust manner without prior calibration.

According to the inventive concept, a method is used to detect the relative position of a stationary induction charging device to a mobile induction charging device, wherein the stationary induction charging device has a stationary energy coil and the mobile induction charging device has a mobile energy coil. In a charging operation, the energy coils are spaced apart from one another in a vertical direction and overlap one another transversely to the vertical direction. In the charging operation, one of the energy coils generates an alternating magnetic field which induces a voltage in the other energy coil for energy transfer.

In order to detect the relative position of the energy coils to one another, at least two distinguishable fields are generated in one of the induction charging devices, which are fixed with respect to the energy coil of the associated induction charging device, i.e. the energy coil of the induction charging device generating the fields. These fields are received in the other induction charging device to detect the relative position of the energy coils to one another. The respective field has an intensity maximum. At least one of the fields is generated in such a manner that its intensity maximum is spaced transversely to the height direction from the energy coil of the associated induction charging device. The respective field with the intensity maximum spaced transversely to the height direction from the energy coil of the associated induction charging device is hereinafter also referred to as the approach field and its intensity maximum as the approach intensity maximum. For the local ratio between at least one of the at least one approach fields and at least one of the at least one further fields, a ratio range is predetermined in advance, which is also referred to below as the approach ratio range. The predetermined ratio range is such that the energy coils approach one another transversely to the height direction. This means that for at least one of the at least one approach fields and at least one of the at least one further fields, an approach ratio range is predetermined in advance for which the energy coils approach one another transversely to the height direction. To detect the relative position of the energy coils to one another, a ratio between at least one of the at least one received approach fields and at least one of the at least one received further fields is determined, which is also referred to below as approach ratio. In doing so, it is detected that the mobile energy coil approaches the stationary energy coil transversely to the height direction if at least one of the at least one determined approach ratios lies in the associated approach ratio range.

The detection of the approach advantageously comprises the detection of the distance of the energy coils from one another when the determined approach ratio moves out of the predetermined associated approach ratio range.

The relevant energy coil preferably has at least one winding. In the scope of the present invention, the extension of the energy coil is to be understood as meaning in particular the entire surface area spanned by the at least one winding. In the case of a flat coil, even the central region, in which no winding can be present, thus belongs to the energy coil.

The fields can be generated in any manner in the induction charging device that generates the fields.

Advantageously, at least one of the fields, preferably the respective field, is a magnetic and/or electromagnetic field.

Preferably, at least one of the fields, preferably the respective field, is a magnetic field. This means that at least one of the fields, preferably the respective field, is generated as a magnetic field. A magnetic field has the advantage over an electromagnetic field that the receiver receives the field more easily and reliably. In addition, it is in this manner possible to dispense with calibration, which is necessary, for example, in the case of runtime differences, as are usually required for electromagnetic and/or acoustic fields. The magnetic field thus allows for a simplified and robust determination of the ratios and thus of the position of the energy coils relative to one another. In particular, the elimination of the calibration carried out during the relevant positioning further means that the positioning can be carried out between different induction charging devices. In other words, the use of magnetic fields allows positioning to be easily implemented with different induction charging devices.

Advantageously, a coil is provided for each field, which is also referred to as a transmission coil. Thus, the induction charging device, which generates at least two fields, preferably has at least two transmission coils, namely an associated transmission coil for the respective field. The transmission coil that generates the respective approach field is also referred to below as the approach transmission coil.

At least one of the transmission coils can be the energy coil of the associated induction charging device.

Preferably, the transmission coils are different from the energy coil of the associated induction charging device.

The fixed position of the fields, especially the intensity maxima, relative to the energy coil can be achieved in any manner.

Advantageously, the fixed position of the fields, in particular the intensity maxima, to the energy coil of the associated induction charging device is achieved by a corresponding positioning of the transmission coils.

Expediently, the fields forming the respective approach ratio range overlap, preferably within the entire approach ratio range.

The detection of the relative position of the energy coils to one another is advantageously carried out by comparing at least one determined approach ratio with the associated approach ratio range.

The at least one approach ratio range is preferably stored. This simplifies the implementation of the method.

The reception of the at least one approach field in the other induction charging device can take place in any manner.

Advantageously, the induction charging device receiving the fields has at least one receiver fixed to the associated energy coil, which interacts with the fields.

It is particularly conceivable that the induction charging device has a single such receiver.

In principle, the at least one receiver can be designed in any way.

For example, at least one of the at least one receiver can have at least one coil, hereinafter also referred to as receiver coil. It is conceivable that at least one of the at least one receiver is such a receiver coil.

At least one of the at least one receiver coils may correspond to the energy coil of the associated induction charging device. This means that the energy coil of the induction charging device can be used as an energy coil in charging operation and as a receiver coil for detecting positioning, i.e. in detection operation.

Advantageously, the energy coil of the receiving induction charging device is different from the at least one receiver coil.

Preferably, the detection of the relative position of the energy coils to one another takes place outside of the charging operation, i.e. in an operating mode different from the charging operation, which is also referred to below as detection operation.

The detection operation is advantageously started when a predetermined distance between the induction charging devices perpendicular to the height direction is fallen below.

Preferably, a ping signal is sent out by one of the induction charging devices, preferably by the mobile induction charging device, which is received by the other induction charging device, wherein the detection operation is started upon receipt of the ping signal.

The detection operation is expediently terminated when the energy coils are aligned to one another. Once the energy coils are aligned, the charging operation can begin.

In detection operation, the energy coils are positioned and aligned relative to one another. The detection operation preferably comprises causing the energy coils to approach one another. The detection operation preferably further comprises a precise positioning of the energy coils relative to one another, hereinafter also referred to as near-field positioning. The at least one approach field is advantageously used to cause the energy coils to approach one another.

The approach is advantageously used when the energy coils are spaced apart from one another transversely to the height direction by less than 1.5 m, in particular less than 1.0 m, for example between 1.0 m and 0.5 m. Near-field positioning is used when this distance is fallen below, in particular when the energy coils are spaced apart from one another by less than 1.5 m, for example less than 1.0 m, in particular less than 0.5 m transverse to the height direction.

The induction charging devices are used for inductive energy transfer, wherein during the charging operation one of the energy coils acts as the primary coil and the other energy coil as the secondary coil. In particular, energy is transferred inductively from the stationary induction charging device to the mobile induction charging device.

The mobile induction charging device is preferably attached to an associated mobile application, in particular to a motor vehicle. Preferably, energy is inductively transferred to the application by means of the mobile induction charging device in order, for example, to charge a battery of the application, in particular of the motor vehicle.

The at least one further field can be another approach field.

In preferred embodiments, at least two such approach fields are generated in the induction charging device generating the fields, which are distinguishable from one another, wherein the intensity maxima of the approach fields are spaced apart from one another.

Particularly preferably, for at least two of the at least two approach fields, a ratio range is predetermined in advance, for which an approach of the mobile energy coil to the stationary energy coil exists. The detection of the approach of the energy coils is carried out by determining a ratio of the received approach fields and detecting an approach if at least one of the at least one ratios is within the associated ratio range.

In preferred embodiments, at least two distinguishable approach fields are generated in the induction charging device generating the fields. At least two of the approach fields are generated such that the approach intensity maxima of the approach fields to the associated energy coil follow one another in a direction running transversely to the height direction, which is also referred to below as the distance direction. Furthermore, for at least two of the approach fields with approach intensity maxima that follow one another in the distance direction, an approach ratio range is predetermined in advance, for which the mobile energy coil approaches the stationary energy coil in the distance direction. In detection operation, an approach ratio between at least two of the received approach fields is determined. If at least one of the at least one determined approach ratios lies in the associated approach ratio range, it is detected that the mobile energy coil is approaching the stationary energy coil in the distance direction. In this manner, an approach of the mobile energy coil to the stationary energy coil in the distance direction is achieved in a simple and reliable manner. Thus, it is not only possible to generally detect an approach, but also to assign a direction to the approach, namely the distance direction.

In a further development of the above-mentioned preferred embodiments, at least three approach fields are generated such that the approach intensity maxima of the approach fields follow one another in the distance direction. In detection operation, an approach ratio between at least two of the received approach fields is determined. If the approach ratios are determined in the order of the distance of the corresponding approach intensity maxima in the distance direction to the stationary energy coil, it is detected that the mobile energy coil approaches the stationary energy coil in the distance direction. Thus, not only a direction of approach of the mobile energy coil to the stationary energy coil is detected, but also a distance between the energy coils in the distance direction. A sequence of the determined approach ratios in the said order indicates that the distance between the mobile energy coil and the stationary energy coil decreases along the distance direction.

In preferred embodiments, at least two distinguishable approach fields are generated in the induction charging device generating the fields. Two of the approach fields are generated such that the approach intensity maxima of the approach fields are spaced from the associated energy coil and arranged opposite one another in a direction, which is also referred to below as the overlap direction. For the approach fields with approach intensity maxima opposite to one another in the overlap direction, an approach ratio range is predetermined in advance, for which the mobile energy coil overlaps with the stationary energy coil along the overlap direction and is spaced from the stationary energy coil in a direction transverse or inclined to the overlap direction, which is also referred to below as the distance direction. Preferably, the distance direction corresponds to the distance direction mentioned above. In detection operation, an approach ratio between at least two of the received approach fields is determined. If at least one of the at least one determined approach ratios lies in the associated approach ratio range, it is detected that the mobile energy coil approaches the stationary energy coil in the distance direction and overlaps with the stationary energy coil in the overlap direction. Thus, in addition to detecting the approach in the distance direction, an existing overlap of the energy coils in the overlap direction is also detected.

Preferably, the approach fields are generated such that the distance direction and the overlap direction run transversely to one another and/or transversely to the height direction. A simplified detection of the position of the energy coils relative to one another is thereby achieved. In addition, this makes it easier to navigate the mobile induction charging device to the stationary induction charging device to achieve charging operation.

Accordingly, it is preferred if at least two of the approach fields are generated such that the overlap direction corresponds to a transverse direction running transversely to the height direction. The corresponding approach ratio range is predetermined in advance such that the distance direction corresponds to a longitudinal direction running transversely to the height direction and transversely to the transverse direction.

In a further development of the above-mentioned preferred embodiments, at least four approach fields that can be distinguished from one another are generated such that a pair of the approach intensity maxima are arranged opposite one another parallel to the overlap direction and the pairs are spaced apart from one another in the distance direction. For each pair, an associated approach ratio range is predetermined in advance. When the approach ratios of the pairs are determined in the order of their distance to the associated energy coil in the distance direction, it is detected that the mobile energy coil approaches the stationary energy coil in the distance direction and overlaps with the stationary energy coil in the overlap direction. Thus, not only an overlap of the energy coils in the overlap direction that persists along the distance direction is detected, but also an approach of energy coils along the distance direction. A sequence of the determined approach ratios in the said order of the pairs means that the distance between the mobile energy coil and the stationary energy coil decreases along the distance direction.

For precise positioning of the energy coils relative to one another, i.e. for detecting the longitudinal and transverse overlapping arrangement of the energy coils, fields are preferably used, which are also referred to below as positioning fields. The positioning fields are preferably used for near-field positioning.

The positioning fields are distinguishable from one another and from the respective at least one approach field. The positioning fields are generated such that they are distinguishable from one another and such that the energy coil of the associated induction charging device, i.e. the induction charging device which generates the positioning fields, is fixedly positioned relative to the positioning fields. The respective positioning field has an intensity maximum, which is also referred to below as the positioning intensity maximum.

The positioning fields are generated such that the energy coil of the associated induction charging device is at least partially located in a virtual frame volume delimited by at least two positioning intensity maxima and extending in the height direction. The frame volume is preferably spaced from the at least one approach intensity maximum of the at least one approach field.

In preferred embodiments, the at least one approach field and the positioning fields are generated in the same induction charging device.

At least one of the positioning fields can be used as a further field. This means that at least one approach field and at least two positioning fields are generated such that the positioning fields are distinguishable from one another and from the at least one approach field, and such that the energy coil of the associated induction charging device is fixedly positioned relative to the positioning fields. For at least one of the approach fields and at least one of the positioning fields, an approach ratio range is predetermined in advance, for which the mobile energy coil approaches the stationary energy coil. To detect the relative position of the energy coils to one another, an approach ratio between at least one of the at least one received approach fields and at least one of the at least one received positioning fields is determined. If at least one of the at least one determined approach ratios lies in the associated approach ratio range, it is detected that the mobile energy coil is approaching the stationary energy coil.

To detect the relative position of the energy coils to one another in near-field positioning by means of the positioning fields, the positioning fields are received at least at one position fixed to the energy coil of the other induction charging device. In this case, a positioning ratio range of at least two of the received positioning fields is predetermined in advance, for which the energy coil of the induction charging device receiving the positioning fields is arranged in the frame volume. To detect the relative position of the energy coils to one another, the positioning ratio between at least two of the received positioning fields is determined. In doing so, it is detected that the energy coils are arranged in the frame volume and overlap transversely to the height direction if at least one of the at least one determined positioning ratios lies within the associated predetermined positioning ratio range.

The detection of the relative position of the energy coils to one another is advantageously carried out by comparing at least one determined positioning ratio with the associated positioning ratio range.

The at least one positioning ratio range is preferably stored. This simplifies the implementation of the method.

Advantageously, at least two of the positioning fields, in particular all positioning fields, overlap in the frame volume.

The positioning fields can be received in the other induction charging device in any manner.

Preferably, for this purpose, at least one receiver is used in the other induction charging device, which receiver is preferably fixed in relation to the energy coil of the receiving induction charging device and interacts with the positioning fields.

It is particularly conceivable that the receiving induction charging device has a single such receiver.

In principle, the at least one receiver can be designed in any way.

For example, at least one of the at least one receiver can have at least one coil, hereinafter also referred to as receiver coil. It is conceivable that at least one of the at least one receiver is such a receiver coil.

It is conceivable that the same receiver is used to receive at least one of the at least one approach fields and at least one of the at least one positioning fields.

The positioning fields can be generated in any manner in the induction charging device that generates the positioning fields.

Advantageously, a coil is provided for the respective positioning field, which is also referred to below as a positioning transmission coil. Thus, the induction charging device, which generates at least two positioning fields, preferably has at least two positioning transmission coils, namely an associated positioning transmission coil for the respective positioning field.

At least one of the positioning transmission coils can be the energy coil of the associated induction charging device.

Preferably, the positioning transmission coils are different from the energy coil of the associated induction charging device.

The fixed position of the positioning fields, in particular the positioning intensity maxima, relative to the energy coil can be achieved in any manner.

Advantageously, the fixed position of the positioning fields, in particular the positioning intensity maxima, to the energy coil of the associated induction charging device is achieved by a corresponding positioning of the positioning transmission coils.

In preferred embodiments, a tolerance is permitted for at least one of the at least one ratio ranges, that is, for at least one of the at least one positioning ratio ranges and/or for at least one of the at least one approach ratio ranges. This makes it possible, in particular, to use the same stationary induction charging device with mobile induction charging devices arranged at different heights in the associated application, i.e. for different distances in the height direction. In particular, it is thus still possible to achieve reliable and robust detection of the relative position of the energy coils to one another when using the mobile induction charging device in motor vehicles of different heights, for example in a sports car, an SUV or a truck.

Alternatively or additionally, it is conceivable to predetermine in advance corresponding ratio ranges for different distances between the energy coils in the height direction during charging operation.

Embodiments are considered advantageous in which a virtual target volume extending in the height direction is defined within the frame volume, such that the energy coil of the induction charging device generating the positioning fields is located in the target volume. In addition, at least one of the positioning ratio ranges is predetermined such that the energy coil of the induction charging device receiving the positioning fields is at least partially arranged in the target volume. If a positioning ratio is determined in the positioning ratio range corresponding to the target volume, it is detected that the energy coils within the target volume overlap transversely to the height direction. Since the target volume is smaller than the frame volume, an increased precision in detecting the relative position of the energy coils to one another is achieved. This also makes it possible to align the energy coils more precisely relative to one another.

In principle, the frame volume and/or the target volume can be chosen arbitrarily.

The frame volume and the target volume are expediently selected in such a manner that high efficiencies are achieved when the energy coils overlap within the frame volume or the target volume during charging operation.

Preferably, the frame volume and/or the target volume is selected in such a manner that an efficiency of at least 90% is achieved with an overlapping arrangement of the energy coils within the volume during charging operation.

The target area is preferably the size of a DIN A5 sheet of paper. The target area is preferably about 7.5 cm long and about 10 cm wide, or vice versa.

Here the frame volume and the target volume can each be assigned associated positioning ratio ranges. Appropriately, the at least one positioning ratio range assigned to the target volume is narrower than the at least one positioning ratio range assigned to the frame volume.

For example, at least one of the at least one positioning ratio ranges assigned to the target volume may be between 1:0.1 and 0.1:1.

For example, at least one of the at least one positioning ratio ranges assigned to the frame volume may be between 10:0.05 and 0.05:10.

In preferred embodiments, at least two of the opposite positioning intensity maxima are assigned a direction. This makes it possible to recognize in particular that the energy coils overlap in that direction.

Accordingly, preferred embodiments are those in which the positioning fields are generated such that the positioning intensity maxima of at least two positioning fields are arranged opposite one another in a longitudinal direction running transversely to the height direction, wherein these positioning fields are also referred to below as longitudinal positioning fields. Furthermore, for at least two of the longitudinal positioning fields, an associated positioning ratio range is predetermined in advance, which is also referred to below as the longitudinal positioning ratio range. From the received positioning fields, a positioning ratio between at least two of the longitudinal positioning fields is determined, which is also referred to below as the longitudinal positioning ratio. If the determined longitudinal positioning ratio is within the corresponding predetermined longitudinal positioning ratio range, it is detected that the energy coils overlap in the longitudinal direction.

Accordingly, preferred embodiments are those in which the positioning fields are generated such that the positioning intensity maxima of at least two positioning fields are arranged opposite one another in a transverse direction running transversely to the height direction, wherein the positioning fields are also referred to below as transverse positioning fields. For at least two of the transverse positioning fields, an associated positioning ratio range is also predetermined in advance, which is also referred to below as the transverse positioning ratio range. From the received positioning fields, a positioning ratio between at least two of the transverse positioning fields is determined, which is also referred to below as the transverse positioning ratio. If the determined transverse positioning ratio is within the corresponding predetermined transverse positioning ratio range, it is detected that the energy coils overlap in the transverse direction.

It is preferred if both at least two longitudinal positioning fields and at least two transverse positioning fields are generated, wherein an associated transverse positioning ratio range is predetermined in advance for at least two longitudinal positioning fields and an associated transverse positioning ratio range is predetermined in advance for at least two transverse positioning fields, and wherein at least one longitudinal positioning ratio and at least one transverse positioning ratio are determined from the received positioning fields. This results in an increased precision in detecting the position of the energy coils relative to one another.

Accordingly, it is preferred if an overlap of the energy coils is detected if the determined longitudinal positioning ratio is within the associated predetermined longitudinal positioning ratio range and if the determined transverse positioning ratio is within the associated predetermined transverse positioning ratio range.

Preferably, the longitudinal direction and the transverse direction run transversely to one another. This enables a simplified detection of the position of the energy coils relative to one another. In addition, the overlapping arrangement of the energy coils can be implemented more easily in this manner by a relative movement of the induction charging devices to one another.

It is preferred if, when using the mobile induction charging device in a motor vehicle, the longitudinal direction corresponds to the X-direction and the transverse direction corresponds to the Y-direction of the motor vehicle, or vice versa.

It is conceivable to generate the longitudinal positioning fields in the stationary induction charging device and to receive them in the mobile induction charging device and to generate the transverse positioning fields in the mobile induction charging device and to receive them in the stationary induction charging device, or vice versa.

In preferred embodiments, all positioning fields are generated in one induction charging device and received in the other induction charging device. This leads to a simplified implementation of the method.

Preferred embodiments are those in which the positioning fields are generated such that two pairs of positioning intensity maxima spaced apart from one another are arranged opposite one another in the longitudinal direction and/or two pairs of positioning intensity maxima spaced apart from one another are arranged opposite one another in the transverse direction. Thus, two positioning ratios or associated positioning ratio ranges are available for detecting the overlapping arrangement of the energy coils in the longitudinal direction and/or in the transverse direction. This results in an increased precision in detecting the position of the energy coils relative to one another.

It is preferred if the positioning fields are generated such that two pairs of positioning intensity maxima spaced apart from one another are arranged opposite one another in the longitudinal direction and two pairs of positioning intensity maxima spaced apart from one another are arranged opposite one another in the transverse direction.

Advantageously, the positioning ratio of both positioning fields having the opposite positioning intensity maxima is determined and, if the positioning ratios deviate, the positioning ratio of the positioning fields with the lower intensity is used to detect the relative position. Since the positioning intensity maximum of the relevant positioning field has a local curve in the form of a double hump, the use of identified positioning ratios between the two humps for detecting the relative position of the energy coils to one another is avoided. As a result, distortions in the detection of the position of the energy coils relative to one another are prevented or at least reduced.

Advantageously, the positioning ratio of both positioning fields having the opposite positioning intensity maxima is identified and, if the positioning ratios match, the two positioning ratios are averaged to detect the relative position. This leads to increased accuracy and robustness for detecting the relative position of the energy coils.

In particular, a match between the two positioning ratios means that the two positioning ratios are substantially the same or within a predetermined mean range.

To generate the longitudinal positioning fields and the transverse positioning fields, four positioning transmission coils are advantageously used.

It is understood that more than four positioning fields are also used.

Preferably, the positioning transmission coils are arranged in the corners of a rectangle. Thus, the positioning field generated with the respective positioning transmission coil is both a transverse positioning field and a longitudinal positioning field. This leads to a simplified design of the induction charging device having the positioning transmission coils.

In advantageous embodiments, if the identified positioning ratio deviates from the associated positioning ratio range towards a positioning intensity maximum of one of the associated positioning fields, an offset of the energy coil of the induction charging device receiving the positioning fields to the energy coil of the induction charging device generating the positioning fields is detected towards the positioning intensity maximum towards which the identified positioning ratio is offset. Thus, not only an offset of the energy coils to one another is detected, but also a direction of the offset. In addition to an increased precision of the detection of the relative position of the energy coils to one another, it is thus possible to carry out a relative movement of the mobile induction charging device to the stationary induction charging device such that this offset is eliminated. This means that simplified navigation of the mobile induction charging device or the associated application is enabled.

Preferably, a position signal is output depending on an identified value of at least one identified positioning ratio for the associated positioning ratio range.

The position signal can be used via an output apparatus as instructions for a person to navigate the mobile induction charging device or the associated application and/or as a control signal for the automated navigation of the mobile induction charging device or the associated application in relation to one another such that the navigation leads to an overall overlapping arrangement of the energy coils in relation to one another transversely to the height direction.

Preferably, the positioning fields are generated such that, for a predetermined centering longitudinal positioning ratio in the longitudinal positioning ratio range, a centered arrangement of the energy coils in the longitudinal direction is present. Thus, a longitudinally centered overlapping arrangement of the energy coils relative to one another can be detected and/or navigation towards such an arrangement can be achieved in a simplified manner.

Alternatively or additionally, preferably additionally, the positioning fields are generated such that, for a predetermined centering transverse positioning ratio in the transverse positioning ratio range, there is an arrangement of the energy coils centered relative to one another in the transverse direction. Thus, a transversely centered overlapping arrangement of the energy coils relative to one another can be detected and/or navigation towards such an arrangement can be achieved in a simplified manner.

In summary, it is thus possible to achieve an overall centered arrangement of the energy coils relative to one another transversely to the height direction. This leads to increased efficiency during charging operation.

In principle, the respective centering positioning ratio can be chosen arbitrarily. In particular, at least one of the centering-positioning ratios may be 1:1 or substantially 1:1. This makes it easier to identify the centered arrangement and/or to navigate towards the centered arrangement.

In preferred embodiments, the positioning fields are generated such that at least one of the positioning ratio ranges, preferably the respective positioning ratio range, is spaced from the positioning intensity maxima of the associated positioning fields. This means that the positioning intensity maxima lie outside at least one of the at least one positioning ratio ranges, preferably outside all positioning ratio ranges. Since the positioning intensity maximum of the relevant positioning field, as explained above, has a local curve in the form of a double hump, the use of identified positioning ratios between the two humps for detecting the relative position of the energy coils to one another is avoided. As a result, distortions in the detection of the position of the energy coils relative to one another are prevented or at least reduced.

In principle, at least two of the positioning fields can be generated with different intensity curves.

In advantageous embodiments, positioning fields with identical intensity curves are generated. This achieves the operation of the induction charging device generating the positioning fields and/or a simplified reception and/or a simplified differentiation of the positioning fields.

It is preferred to generate the positioning fields such that an overall intensity curve of the positioning fields is symmetrical to the energy coil of the induction charging device generating the positioning fields. Thus, based on the symmetry of the overall intensity curve, the relative position of the energy coils to one another can be easily detected and/or the navigation towards the centered arrangement can be simplified.

The generation of the fields in such a manner that they can be distinguished from one another can in principle be done in any way.

It is particularly conceivable that the fields are generated with different frequencies so that the fields can be distinguished from one another.

Advantageously, the fields are generated at frequencies between 5 kHz and 150 kHz. Preferably, the fields are generated at frequencies between 110 kHz and 148.5 kHz, particularly preferably between 120 kHz and 145 kHz.

The frequencies associated with the fields are preferably spaced as closely as possible relative to one another, so that the total frequency spectrum required is narrow. The frequencies are, for example, 5 kHz or 1 kHz or 100 Hz or 1 or a few Hertz apart.

Alternatively or additionally, it is conceivable to generate the fields with respective duty cycles so that the fields can be distinguished. Thus, the fields are differentiated using so-called “duty cycles”.

In preferred embodiments, the positioning fields are generated in the stationary induction charging device and received in the mobile induction charging device. Since a relative movement of the mobile induction charging device in relation to the stationary induction charging device takes place in order to align the energy coils relative to one another, the determination of at least one positioning ratio and the detection of whether there is an overlap of the energy coils can thus take place in the mobile induction charging device. In comparison to a corresponding determination in the stationary induction charging device and a transfer to the mobile induction charging device or to the associated application, the results are thus available in the mobile induction charging device or in the application. In other words, a latency in detecting the position of the energy coils relative to one another is prevented or at least reduced. This results in particular in a smooth navigation of the mobile induction charging device or of the application having the mobile induction charging device.

Preferably, a main axis of the relevant field runs along the height direction. The respective field therefore spreads at least predominantly in or along the height direction and can therefore only be received locally transversely to the height direction. Thus, the fields are used to determine the relative position locally and such main axes have the advantage that the determination of the relative position is more precise, in particular because the relevant volume is defined more precisely. On the other hand, overlaps between fields of induction charging devices that are adjacent transversely to the height direction, for example of adjacent stationary induction charging devices, are prevented or at least reduced in this manner. The latter results in turn to a more precise determination of the relative position as well as to a simplified, interference-reduced and reliable operation of several neighboring induction charging devices, for example of neighboring stationary induction charging devices.

The main axis of a field running along the height direction is advantageously achieved by winding the associated transmission coil around a winding axis running parallel or substantially parallel to the height direction. The transmission coil thus has at least one conductor track through which current flows during operation and which is wound around the winding axis running parallel or substantially parallel to the height direction.

The method according to the invention can be used to detect the position of the energy coils relative to one another at any distance. In particular, the method according to the invention can be used to navigate and align the energy coils relative to one another in any distance ranges.

The induction charging devices are usually part of a system.

Preferably, in the system, the mobile induction charging device is attached to an associated mobile application, in particular to a motor vehicle.

The method can be carried out by a computer program product which is designed accordingly.

The computer program product for detecting the relative position between the energy coils of the stationary induction charging device and the mobile induction charging device advantageously contains instructions that can be read by a computer system, such that the computer system executes the method when executing the computer program product.

The computer program product is advantageously stored on a storage system having at least one non-volatile memory.

The computer program product advantageously contains instructions which cause the system to execute the method.

It is understood that the computer program product also falls within the scope of this invention.

It is further understood that the system also falls within the scope of this invention. To carry out the method, the system can have a suitably designed control apparatus.

The control apparatus can at least partially contain the computer program product and/or at least partially comprise the computer system.

It is further understood that a mobile application, in particular a motor vehicle, with the mobile induction charging device of such a system also belongs to the scope of this invention. Furthermore, it is clear that a stationary induction charging device of such a system also belongs to the scope of this invention.

Further important features and advantages of the invention are apparent from the subclaims, from the drawings and from the associated description of the figures with reference to the drawings.

It is understood that the features mentioned above and those to be explained below can be used not only in the combination specified in each case, but also in other combinations or on their own, without departing from the scope of the present invention.

Preferred embodiments of the invention are illustrated in the drawings and are explained in more detail in the following description, wherein identical reference numerals refer to identical or similar or functionally identical components.

### BRIEF DESCRIPTION OF THE DRAWINGS

In the drawings, schematically in each case:

FIG. 1 shows a highly simplified representation of a system for inductive energy transfer,

FIG. 2 shows a simplified, schematic plan view of an induction charging device of the system,

FIG. 3 shows a simplified diagram with an approach field and a positioning field of the induction charging device,

FIG. 4 shows a simplified, schematic plan view of the induction charging device in another embodiment,

FIG. 5 shows a simplified diagram with approach fields of the induction charging device of FIG. 4,

FIG. 6 shows a diagram with the approach fields from FIG. 5 with a more detailed depiction,

FIG. 7 shows a simplified, schematic plan view of the induction charging device in a further embodiment,

FIG. 8 shows a simplified diagram with approach fields of the induction charging device of FIG. 7,

FIG. 9 shows a simplified schematic plan view of the induction charging device in another embodiment,

FIG. 10 shows a simplified diagram with approach fields of the induction charging device of FIG. 9,

FIG. 11 shows a simplified, schematic plan view of the induction charging device in a further embodiment,

FIG. 12 shows a schematic depiction of virtual volumes,

FIG. 13 shows a section through the induction charging device,

FIG. 14 shows a diagram with positioning fields,

FIG. 15 shows a flow chart explaining the detection of the relative position of energy coils of a mobile induction charging device to a stationary induction charging device of the system,

FIG. 16 shows a plan view of an energy coil of an induction charging device with transmission coils.

### DETAILED DESCRIPTION

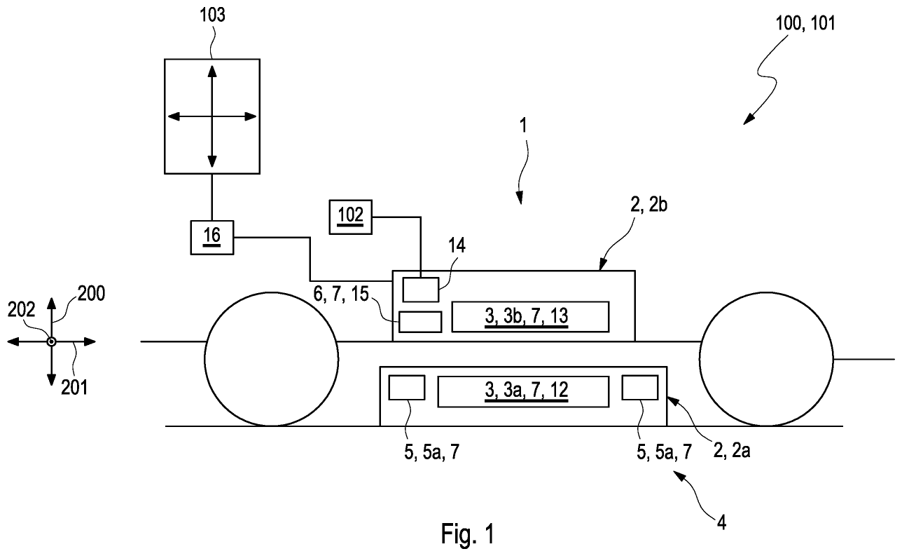

A system 1, as depicted in FIG. 1 in a highly simplified and circuit-diagram-like manner, serves for inductive energy transfer with a mobile application 100, in the shown embodiments to a mobile application 100, in particular to charge a battery 102 of the mobile application 100. In the embodiment shown, the application 100 is a motor vehicle 101. For this purpose, the system 1 has two induction charging devices 2 that interact inductively with one another during a charging operation, namely a stationary induction charging device 2, 2a and a mobile induction charging device 2, 2b for the application 100. For inductive energy transfer during the charging operation, the relevant induction charging device 2 has an associated coil 3. These coils 3 are hereinafter also referred to as energy coils 3. The stationary induction charging device 2, 2a thus has a stationary energy coil 3, 3a and the mobile induction charging device 2, 2b has a mobile energy coil 3, 3b. During charging operation, one of the energy coils 3 thus serves as primary coil 12 which generates an alternating magnetic field that induces a voltage for energy transfer in the other energy coil 3 serving as the secondary coil 13. In the embodiments shown, the energy coils 3 are each designed as a flat coil 7. During charging operation, the induction charging devices 2 are spaced apart from one another in a height direction 200 and overlap transversely to the height direction 200. In order to make charging operation possible and to achieve high efficiencies during charging operation, the energy coils 3 are positioned relative to one another transversely to the height direction 200, i.e., in a longitudinal direction 201 running transversely to the height direction 200 and in a transverse direction 202 running transversely to the height direction 200 and transversely to the longitudinal direction 201. For this purpose, the relative position of the energy coils 3 to one another is detected. Advantageously, this takes place before the charging operation in order to achieve an optimal relative positioning of the energy coils 3 to one another and thus an increased efficiency.

In the embodiments shown, during charging operation, energy is transferred from the stationary induction charging device 2, 2a to the mobile induction charging device 2, 2b in order to charge a battery 102 of the motor vehicle 101. Accordingly, during charging operation, the stationary energy coil 3, 3a serves as the primary coil 12 and the mobile energy coil 3, 3b serves as the secondary coil 13. It is understood that reverse operation and bidirectional operation are also possible. As can be seen from FIG. 1, the mobile induction charging device 2, 2a in the embodiment shown comprises a rectifier 14 connected between the secondary coil 13 and the battery 102 in order to convert the alternating voltage induced in the secondary coil 13 into a rectified voltage. Furthermore, in the embodiments shown, the height direction 200 corresponds to the Z direction of the motor vehicle 101. In addition, the longitudinal direction 201 and the transverse direction 202 correspond purely by way of example to the X direction and the Y direction of the motor vehicle 101.

To position the energy coils 3 relative to one another during charging operation, the approach of the energy coils 3 to one another is detected. The approach is achieved by a corresponding movement of the mobile induction charging device 2, 2b or the application 100 relative to the stationary induction charging device 2, 2a.

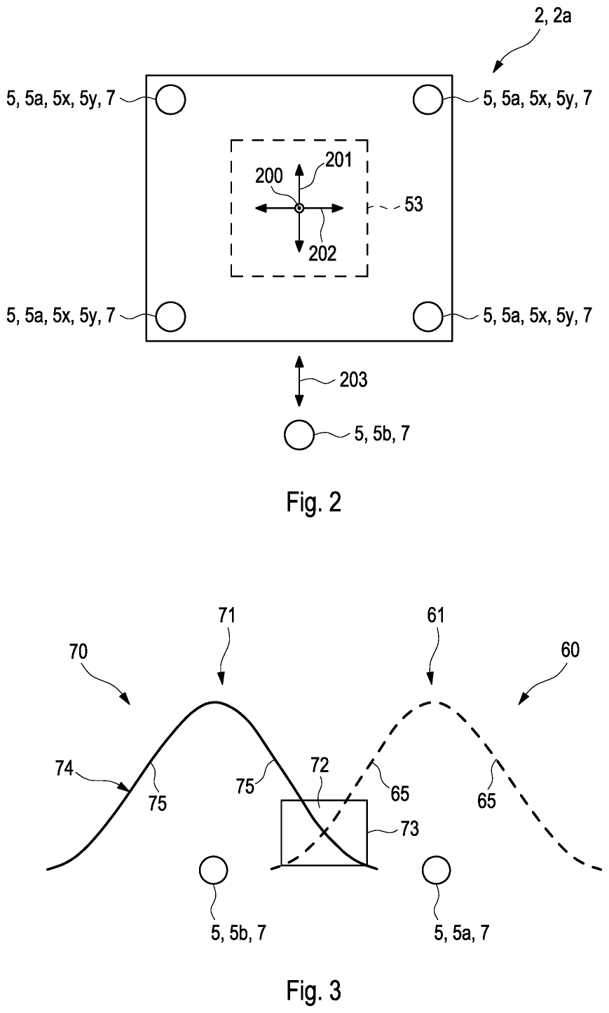

In order to detect the approach of the mobile energy coil 3, 3b to the stationary energy coil 3, 3a, as shown in FIGS. 2 to 11, at least two distinguishable fields 60, 70 are generated in one of the induction charging devices 2, which are received in the induction charging device 2 to detect the relative position of the energy coils 3 to one another. In the embodiments shown, the fields 60, 70 are generated purely by way of example in the stationary induction charging device 2, 2a and received in the mobile induction charging device 2, 2b. It is understood that it is equally possible to generate the fields 60, 70 in the mobile induction charging device 2, 2b and to receive them in the stationary induction charging device 2, 2a. The fields 60, 70 are fixedly positioned relative to the associated energy coil 3, i.e., in the embodiments shown, relative to the mobile energy coil 3, 3a. In the embodiments shown, the respective field 60, 70 is generated by an associated coil 5, which is also referred to below as transmission coil 5. In the embodiments shown, the respective field 60, 70 is magnetic. This means that the induction charging device 2 generating the fields 60, 70 generates magnetic fields 60, 70 which are each distinguishable from one another. The respective field 60, 70 has a spatial intensity curve 64, 74 with an intensity maximum 61, 71. At least one of the fields 70 thereby has an intensity maximum 71, which is spaced transversely to the height direction 200 from the energy coil 3 of the induction charging device 2 generating the fields 60, 70, in this case from the stationary energy coil 3. The respective field 70 with the maximum intensity 71 is spaced from the associated energy coil 3. The respective transmission coil 5 generating an approach field 70 is also referred to below as approach transmission coil 5, 5b.

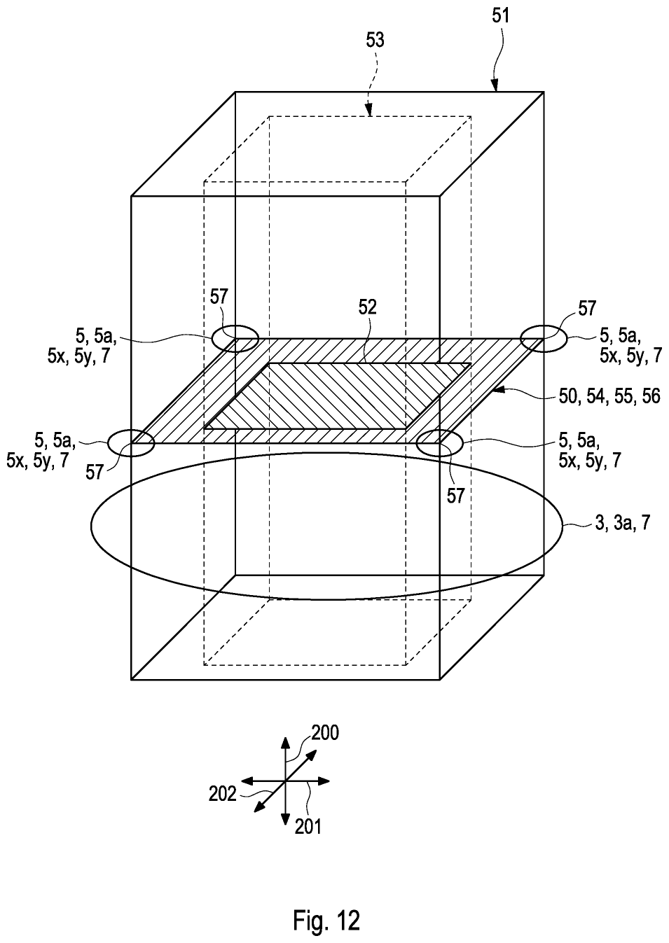

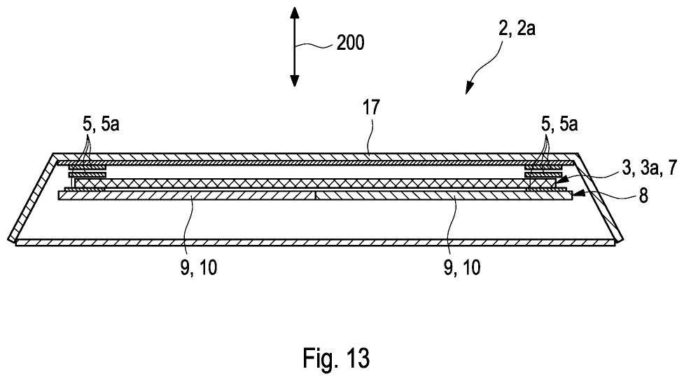

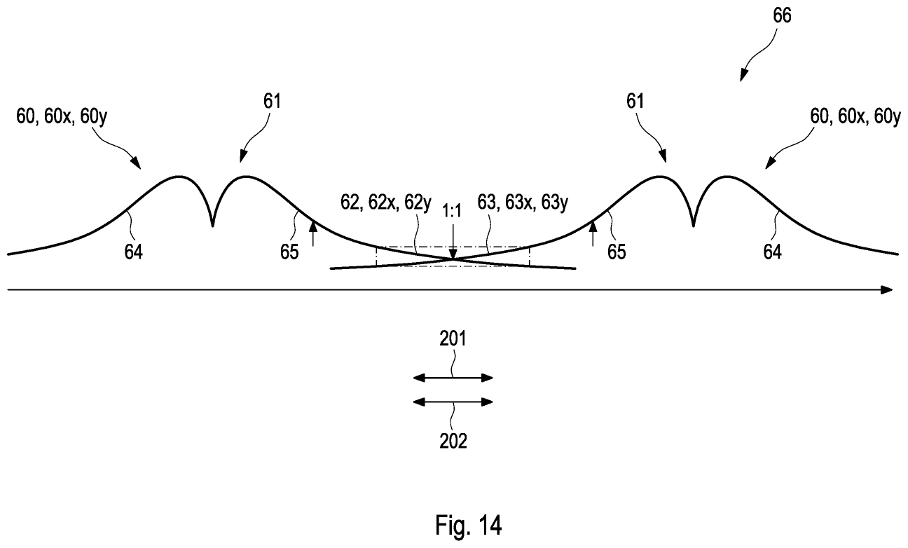

As can be seen, for example, from FIGS. 3 and 12 to 14, the induction charging device 2 generating the at least one approach field 70, in this case the stationary induction charging device 2, 2a, generates at least two further magnetic fields 60, which are also referred to below as positioning fields 60. The positioning fields 60 are distinguishable from the approach fields 70 and from one another. Thus, fields 60, 70 can be distinguished from one another. The respective positioning magnetic field 60 has an intensity maximum 61, which is also referred to below as positioning intensity maximum 61. The positioning fields 60 are explained in more detail below with reference to FIG. 13. The positioning fields 60 are generated such that the energy coil 3 of the associated induction charging device 2 lies at least partially in a virtual volume 51 delimited by at least two positioning intensity maxima 61 of at least two of the positioning fields 60 and extending in the height direction 200, which is explained in more detail below with reference to FIG. 12. The volume 51 is also referred to hereinafter as frame volume 51. The respective approach intensity maximum 71 is preferably spaced from the frame volume 51. In the embodiments shown, the respective positioning field 60 is generated with an associated transmission coil 5, which is also referred to below as positioning transmission coil 5, 5a.

In the embodiments shown, the fields 60, 70 are received in the other induction charging device 2, i.e. in the embodiments shown in the mobile induction charging device 2, 2b, with at least one receiver 6, which interacts with the fields 70 and in the embodiments shown is designed as a coil 15, which is referred to below as receiver coil 15. The approach transmission coils 5, 5b, the positioning transmission coils 5, 5a and the at least one receiver coil 15 can be components of a positioning device 4 of the system 1.

FIGS. 2, 4, 7 as well as 9 and 11 show schematic plan views of the stationary induction charging device 2, 2a, in which the transmission coils 5, which are not visible in the plan view, are nevertheless shown. FIG. 3 shows an approach field 70 and a positioning field 60, wherein the respective associated transmission coil 5 is shown below the associated intensity maximum 61, 71 for the sake of better understanding. FIGS. 5, 6, 8 and 10 show approach fields 70, wherein in these figures the respective associated approach transmission coils 5, 5b are shown below the respective associated approach intensity maximum 71 for better understanding. Thus, the respective at least one approach transmission coil 5, 5b is spaced transversely to the height direction 200 from the stationary energy coil 3, 3a. It can also be seen from the figures that the respective approach field 70 has an intensity curve 74 with intensity flanks 75 leading to the approach intensity maximum 71.

For at least one of the at least one approach fields 70 and at least one of the at least one further fields 60, 70, a range 73 is predetermined in advance for the local ratio of the fields 60, 70, which is also referred to below as approach ratio range 73, wherein the energy coils 3 approach one another within the predetermined approach ratio range 73 transversely to the height direction 200. To detect the relative position of the energy coils 3 to one another, in particular the approach of the energy coils 3, a ratio 72 between the at least one received approach field 70 and the at least one received further field 60, 70 is identified, which is also referred to below as approach ratio 72. In doing so, it is detected that the mobile energy coil 3, 3b approaches the stationary energy coil 3, 3a transversely to the height direction 200 if at least one of the at least one identified approach ratios 72 lies in the associated approach ratio range 73. The detection of the approach also includes recognition of the distance of the energy coils 3 from one another if the identified approach ratio 72 moves out of the associated approach ratio range 73. The relevant approach ratio range 73 is predetermined in advance by means of a fixed specification, so that the ratio range 73 is stored and calibration is not necessary.

In the embodiment of FIG. 2, the stationary induction charging device 2, 2a generates a single such approach field 70. Accordingly, the induction charging device 2, 2a has a single such approach transmission coil 5, 5b. In this embodiment, one of the positioning fields 60 is used as a further field 60, 70. In this embodiment, an approach ratio range 73 is predetermined in advance for the approach field 70 and at least one of the positioning fields 60, for which the mobile energy coil 3, 3b approaches the stationary energy coil 3, 3a. To detect the approach of the energy coils 3 to one another, the approach ratio 72 between the received approach field 70 and at least one of the at least one received positioning fields 60 is determined. In doing so, it is detected that the mobile energy coil 3, 3b approaches the stationary energy coil 3, 3a if at least one of the at least one determined approach ratios 72 lies in the associated approach ratio range 73.

In the embodiments shown in FIGS. 2 to 8, at least two mutually distinguishable approach fields 70 are generated in the stationary induction charging device 2, 2a. Further, at least two of the approach fields 70 are generated such that the approach intensity maxima 71 of the approach fields 70 to the stationary energy coil 3, 3a follow one another in a direction 203 running transversely to the height direction 200, wherein this direction is also referred to below as the distance direction 203. In the embodiments shown, the distance direction 203 runs parallel to the longitudinal direction 201. For at least two of the approach fields 70 with approach intensity maxima 71 following one another in the distance direction 203, a ratio range 73 is further predetermined in advance, for which the mobile energy coil 3, 3b approaches the stationary energy coil 3, 3a in the distance direction 203, wherein the ratio 73 is also referred to below as approach ratio range 73. To detect the relative position of the energy coils 3 to one another, the ratio 72 between at least two of the received approach fields 70 is determined, which is also referred to below as approach ratio 72. If at least one of the at least one determined approach ratios 72 lies within the associated predetermined approach ratio range 63, it is detected that the mobile energy coil 3, 3b is approaching the stationary energy coil 3, 3a in the distance direction 203.

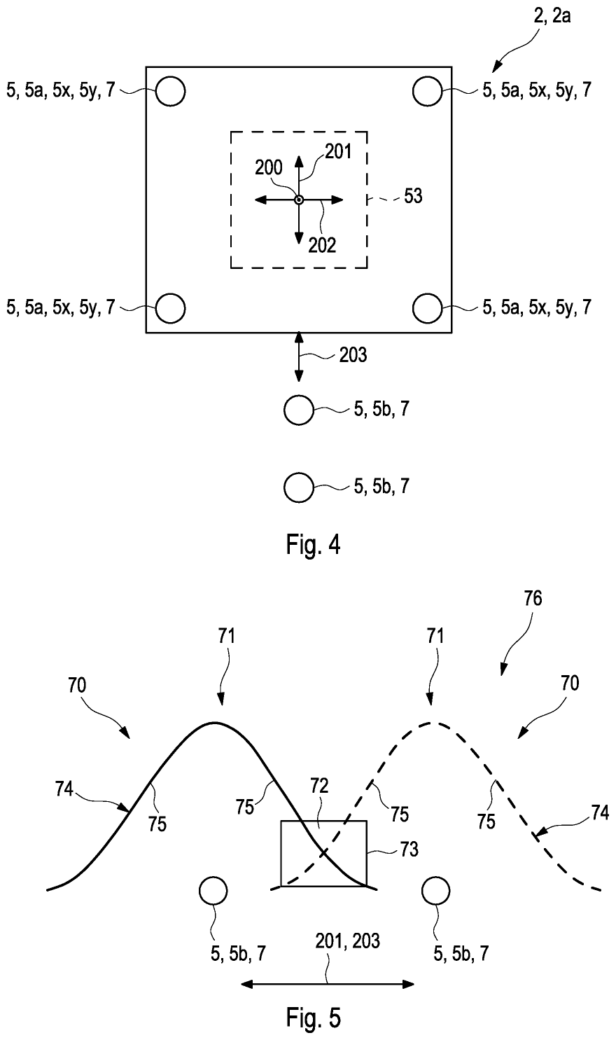

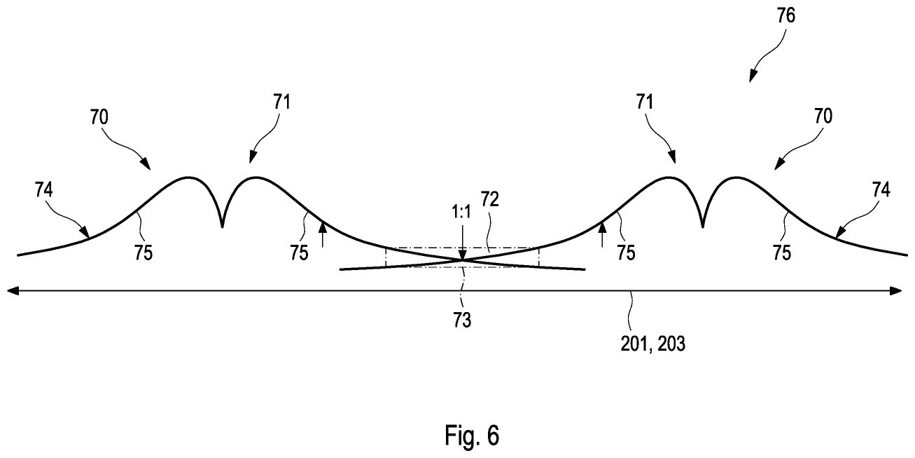

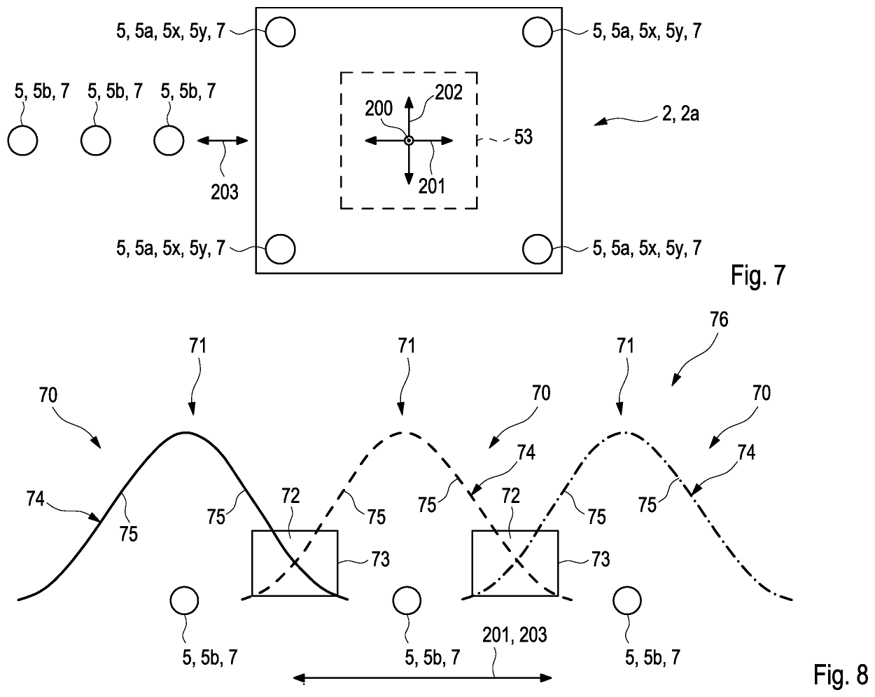

In the embodiment of FIGS. 4 and 5, two approach fields 70 are generated. In FIG. 7, one of the approach fields 70 is shown with a solid line and the other approach field 70 with a dashed line. FIG. 5, like FIGS. 3, 6, 8 and 10, shows an intensity curve 74 of the respective approach field 70. The intensity curve 74 of the approach fields 70 is explained below by way of example with reference to FIGS. 5 and 6. As can be seen from these figures, the approach fields 70 overlap in the distance direction 203. In the embodiments shown, the approach fields 70 have identical intensity curves 74. Furthermore, in the embodiments shown, the approach transmission coils 5, 5b are designed such and the approach fields 70 are generated such that the approach fields 70 are symmetrical to one another in the distance direction 203.

FIG. 5, and analogously FIGS. 3, 6, 8 and 10, show a simplified curve of the approach fields 70 received by the receiver 6 depending on the position along the distance direction 203. FIG. 6 shows the curve in more detail. As can be seen from FIG. 6, the intensity maximum 71 of the relevant approach field 70 is shaped like a double hump. This is in particular due to the fact that when positioned correspondingly the receiver 6 detects a transition of the magnetic field lines (not shown). As indicated in FIGS. 5 and 6, the approach ratio range 72 is spaced between successive intensity flanks 75 of the approach fields 70 and from the intensity maxima 71.

In the embodiments shown in FIGS. 7 and 8, three such approach fields 70 are generated compared to the embodiments shown in FIGS. 4 to 6. In this embodiment, the three approach fields 70 are generated such that the approach intensity maxima 71 of the approach fields 70 follow one another in the distance direction 203. In FIG. 8, the intensity curve 74 of one of the approach fields 70 is shown with a solid line, that of the next adjacent approach field 70 in the distance direction 203 with a dashed line and that of the other approach field 70 with a dot-dashed line. As can be seen from FIG. 8, between each two of the approach fields 70 that follow one another in the distance direction 203, an associated approach ratio range 73 is predetermined in advance. In order to detect the relative position of the energy coils 3 to one another, the approach ratio 72 between the approach fields 70 that follow one another in the distance direction 203 is determined. In doing so, it is detected that the mobile energy coil 3, 3b approaches the stationary energy coil 3, 3a in the distance direction 203 when the approach ratios 72 are determined in the order of the distance of the associated approach intensity maxima 71 in the distance direction 203 to the stationary energy coil 3, 3a.

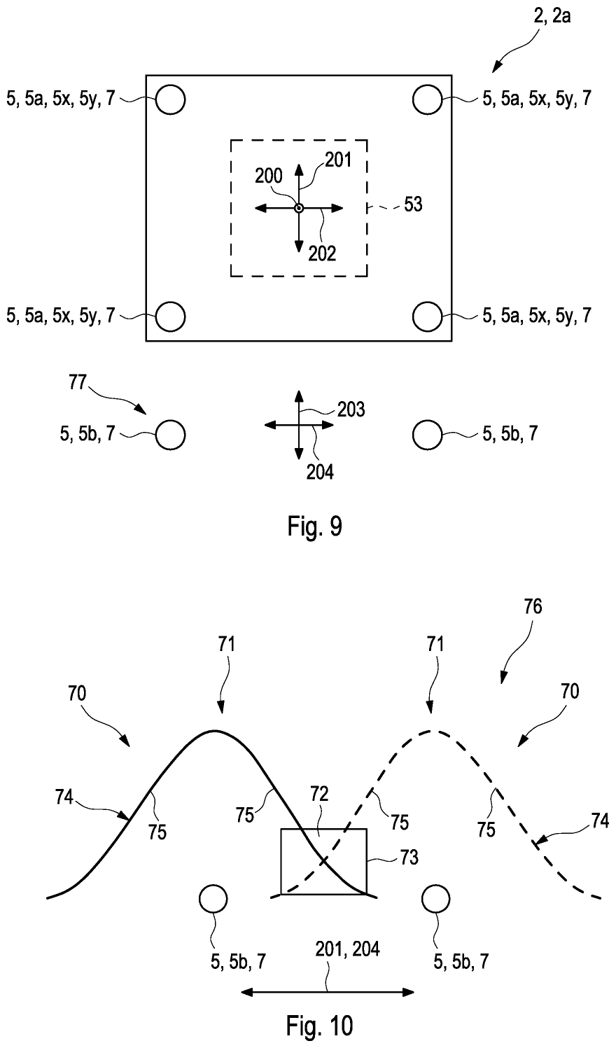

In the embodiments of FIGS. 9 to 11, the stationary induction charging device 2, 2a generates at least two approach fields 70 that can be distinguished from one another, wherein two of the approach fields 70 are generated such that the approach intensity maxima 71 of the approach fields 70 are spaced apart from the stationary energy coil 3, 3a and arranged opposite one another in an overlap direction 204. In the embodiments shown, the overlap direction 204 runs parallel to the transverse direction 202 and thus parallel to the height direction 200 and the distance direction 203.

In the embodiment shown in FIGS. 9 and 10, the induction charging device 2, 2a generates only 2 approach fields 70, the intensity maxima 71 of which are opposite in the overlap direction 204. As shown in FIG. 10, the same applies to the approach fields 70 as to the approach fields 70 of the embodiment shown in FIGS. 4 to 6, with the difference that the overlap direction 204 takes the place of the distance direction 203 in FIGS. 4 to 6. This means that the approach fields 70 overlap in the overlap direction 204. In the embodiment shown, the approach fields 70 have identical intensity curves 74. Furthermore, in the embodiment shown, the approach transmission coils 5, 5b are designed such and the approach fields 70 are generated such that the approach fields 70 are symmetrical to one another in the overlap direction 204. In this case, an approach ratio range 73 is predetermined in advance for the approach fields 70, for which the mobile energy coil 3, 3b overlaps with the stationary energy coil 3, 3a along the overlap direction 204 and is spaced apart from the stationary energy coil 3, 3a in the distance direction 203. The approach ratio range 73 is spaced from the intensity maxima 71 in a manner analogous to the embodiment described above with respect to FIGS. 4 to 6. To detect the relative position of the energy coils 3 to one another, an approach ratio 72 between the received approach fields 70 is determined. In doing so, it is detected that the mobile energy coil 3, 3b approaches the stationary energy coil 3, 3a in the distance direction 203 and overlaps with the stationary energy coil 3, 3a in the overlap direction 204 if at least one of the at least one determined approach ratios 73 lies in the associated approach ratio range 73. When determining an approach ratio 73 within the associated approach ratio range 73, it is therefore detected that the mobile energy coil 3, 3b is aligned in the overlap direction 204 with respect to the stationary energy coil 3, 3a and is offset in the distance direction 203 with respect to the stationary energy coil 3, 3a. The intensity maxima 71 that are opposite one another in the overlap direction 204 form a pair 77.

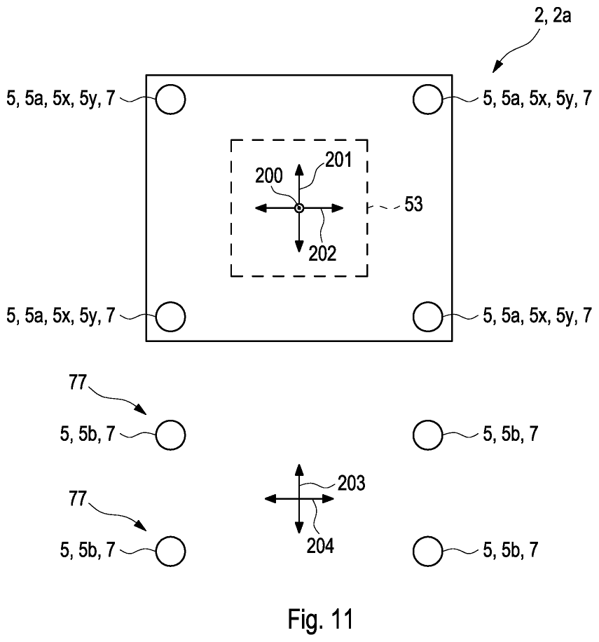

As can be seen from FIG. 11, the embodiment shown in FIGS. 9 and 10 can be extended by further pairs 77 of intensity maxima 71 and consequently approach fields 70, wherein the pairs 77 are spaced apart from one another in the distance direction 203. This means that at least 2 pairs 77 of approach fields 70 are generated, wherein the intensity maxima 71 of the approach fields 70 of the respective pair 77 are opposite one another in the overlap direction 204 and wherein the intensity maxima 71 of the pairs 77 are spaced apart from one another in the distance direction. In the embodiment shown in FIG. 11, 4 such pairs 77 are provided purely by way of example, so that the stationary induction charging device 2, 2a generates a total of 4 approach fields 70 (not shown). Accordingly, the stationary induction charging device 2, 2a has 4 approach transmission coils 5, 5b, wherein 2 of the approach transmission coils 5, 5b are opposite one another in the overlap direction 204 and spaced apart from one another in the distance direction 203. For the respective pair 77, an associated approach ratio range 73 is predetermined in advance, analogous to the embodiment shown in FIGS. 9 and 10. In doing so, it is detected that the mobile energy coil 3, 3b approaches the stationary energy coil 3, 3a in the distance direction 203 and overlaps with the stationary energy coil 3, 3a in the overlap direction 204 when the approach ratios 72 of the pairs 77 are determined in the order of their distance in the distance direction 203 to the stationary energy coil 3, 3a.

The at least one predetermined approach ratio range 73 is preferably stored so that by a simple comparison between the determined approach ratio 72 and the associated approach ratio range 73 it is detected whether the energy coils 3 are approaching one another.

In the embodiments shown, the approach transmission coils 5, 5b are of identical design, i.e., they are identical parts. The respective approach transmission coil 5, 5b is a flat coil 7.

In the embodiments shown, the approach fields 70 are used to detect and/or achieve an approach of the mobile energy coil 3, 3b to the stationary energy coil 3, 3a. This is usually done for distances between the energy coils 3 of at least 0.5 m, for example of at least 1.5 m. This is done in particular in an approach operation.

If the determined approach ratio 72 deviates from the associated approach ratio range 73 towards an approach intensity maximum 71 of one of the associated approach fields 70, an offset of the mobile energy coil 3, 3b towards that approach intensity maximum 71 and thus towards the approach transmission coil 5, 5b generating the approach intensity maximum 71, towards which the approach ratio 72 is shifted, will also be detected. Thus, navigation of the mobile induction charging device 2, 2a can be realized such that the mobile energy coil 3, 3b approaches the stationary energy coil 3, 3a in a targeted manner. This can, as indicated in FIG. 1, be effected by means of an output apparatus 103 in order to output whether and in which direction a relative movement of the mobile induction charging device 2, 2b relative to the stationary induction charging device 2, 2a is necessary in order to achieve a targeted approach. The targeted approach preferably corresponds to an approach in the distance direction 203 and thus in the longitudinal direction 201 as well as an overlap in the overlap direction 204 and thus in the transverse direction 202. In the embodiment shown in FIG. 1, this is effected purely visually by means of the display of arrows indicated in FIG. 1. It is also conceivable for the output apparatus 103 to output an acoustic signal. It is also conceivable to implement the result autonomously, so that the motor vehicle 101 is driven autonomously in order to achieve the approach.

The positioning of the energy coils 3 relative to one another comprises the approach as well as an overlapping positioning of the energy coils 3 relative to one another transversely to the height direction 200 overall, that is to say in the longitudinal direction 201 and in the transverse direction 202. The at least one approach field 70 is advantageously used for the approach of the energy coils 3, in which the energy coils 3 are spaced apart relative to one another and transversely to the height direction 200 by more than 0.5 m or more than 1.0 m or more than 1.5 m, for example between 0.5 m and 1.5 m, in order to detect an approach of the energy coils 3 to one another. The near-field positioning is used when this distance is fallen below, in particular when the energy coils 3 are spaced apart from one another transversely to the height direction 200 by less than 1.5 m, for example less than 1.0 m, in particular less than 0.5 m.

In order to achieve an overlapping positioning of the energy coils 3 relative to one another transversely to the height direction 200 overall, i.e. in the longitudinal direction 201 and in the transverse direction 202, and thus a near-field positioning, and thus to enable the charging operation and/or to effect an increased efficiency of the charging operation, the positioning fields 60 are used in the embodiments shown, as will be explained below in particular with reference to FIGS. 12 to 14. In this case, analogous to the approach fields 70, a positioning ratio range 63 (see FIG. 13) of at least two of the received positioning fields 60 is predetermined in advance, for which the energy coil 3 of the induction charging device 2 receiving the positioning fields 60 is arranged in the frame volume 51. To detect the relative position of the energy coils 3 to one another, the positioning ratio 62 between at least two of the received positioning fields 60 is determined. If at least one of the at least one determined positioning ratios 62 lies within the associated predetermined positioning ratio range 63, it is detected that the energy coils 3 are arranged in the frame volume 51 and overlap transversely to the height direction 200. The relevant positioning ratio range 63 is predetermined in advance by means of a fixed specification, so that the ratio range 63 is stored and calibration is not necessary.

As can be seen from FIG. 12, for example, a total of four positioning transmission coils 5 are provided in the embodiments shown, so that a total of four mutually distinguishable positioning fields 60 are generated. Accordingly, the stationary induction charging device 2, 2a has the positioning transmission coils 5, 5a and the mobile induction charging device 2, 2b has at least one receiver 6. In the embodiments shown, a single receiver 6 is also provided for receiving the positioning fields 60 and the at least one approach field 70. In the view shown in FIG. 1, only two of the positioning transmission coils 5 are visible. Due to the difference between the positioning fields 60, a distinction can be made between the positioning fields 60 by means of the at least one receiver 6.

In the embodiments shown, the positioning transmission coils 5, 5a are different from the first energy coil 3, 3a. In the embodiments shown, the at least one receiver coil 15 is purely by way of example different from the second energy coil 3, 3b. As shown in FIGS. 2 and 12, for example, the positioning transmission coils 5, 5a are spaced apart from one another and in each case two of the positioning transmission coils 5, 5a are arranged opposite one another. In a simple approach, analogous to at least one approach field 70, it can be assumed that the positioned intensity maximum 60 of the respective positioning field 60 is arranged in the height direction 200 above the associated positioning transmission coil 5, 5a. In FIGS. 2, 4, 6, 9 and 11, the positioning transmission coils 5, 5a would not be visible but would still be shown for better understanding.

Since in the embodiments shown the respective positioning field 60 is generated directly by means of an associated positioning transmission coil 5, 5a, the geometric arrangements of the positioning intensity maxima 61 and the associated positioning transmission coils 5, 5a are considered to be analogous. For example, the positioning fields 60 generated by two opposite positioning transmission coils 5, 5a have opposite positioning intensity maxima 61 parallel to the opposite arrangement of the positioning transmission coils 5.

In the embodiments shown, the positioning transmission coils 5, 5a are of identical design, i.e., they are identical parts. The respective positioning transmission coil 5, 5a is a flat coil 7. In addition, the positioning transmission coils 5, 5a and the approach transmission coils 5, 5b are designed identically in the embodiments shown, i.e. they are identical parts.

In the embodiments shown, the respective positioning transmission coils 5, 5a and approach transmission coils 5, 5b designed as flat coils 7 have at least one conductor track that is not explicitly shown wound around an associated winding axis (not shown) running parallel to the height direction 200. The relevant field 60, 70 thus has a main axis running along the height direction 200, i.e., it is at least predominantly spreading in or along the height direction 200 and can thus only be received locally transversely to the height direction 200.

In the embodiments shown, the fields 60, 70 are generated mutually distinguishably, due to the fact that the relevant positioning field 60 is generated with an associated frequency. This means that the respective positioning transmission coil 5, 5a and the respective at least one approach transmission coil 5, 5b are operated with an associated frequency, so that the positioning fields 60 and the at least one approach field 70 can each be distinguished from one another. The frequencies lie in particular in the range between 120 kHz and 145 kHz and are spaced apart from one another by a few Hz to kHz, for example. For example, the frequencies can lie apart by 5 kHz or 1 kHz or 100 Hz or less. Differentiation is also possible by means of duty cycles.

FIG. 12 shows a schematic view in which only the positioning transmission coils 5, 5a and the energy coil 3 of the induction charging device 2 having the positioning transmission coils 5, 5a, in the embodiments shown thus the stationary energy coil 3, 3a, of the system 1 are shown. As can be seen from FIG. 12, the arrangement of the positioning transmission coils 5, 5a is such that the positioning transmission coils 5, 5a delimit a virtual frame 50. The frame 50 is thus a virtual surface area delimited by the positioning transmission coils 5. The virtual frame 50 defines the frame volume 51 extending from frame 50 in the height direction 200. The energy coil 3 of the associated induction charging device 2, in the embodiments shown the stationary energy coil 3, 3a, is at least partially arranged within the virtual frame volume 51. The energy coil 3 of the associated induction charging device 2 is thus either at least partially within the frame 50 or offset in the height direction 200 to the frame 50 and consequently arranged within the frame volume 51. In the embodiments shown, the positioning transmission coils 5, 5a are spaced apart from the energy coil 3 of the associated induction charging device 2 in the height direction 200 and thus from the stationary energy coil 3, 3a (see also FIG. 13). In the embodiments shown, in each case two of the positioning transmission coils 5, 5a are arranged opposite one another in the longitudinal direction 201 and in the transverse direction 202. The positioning transmission coils 5, 5a lying opposite one another in the longitudinal direction 201 are hereinafter also referred to as longitudinal positioning transmission coils 5, 5a, 5x and the positioning transmission coils 5 opposite one another in the transverse direction 202 are hereinafter also referred to as transverse positioning transmission coils 5, 5a, 5y. Accordingly, the positioning fields 60 generated by the longitudinal positioning transmission coils 5, 5a, 5x are hereinafter referred to relative to one another as longitudinal positioning fields 60, 60x and the positioning fields 60 generated by the transverse positioning transmission coils 5, 5a, 5y are hereinafter referred to relative to one another as transverse positioning fields 60, 60y.

As shown in FIG. 12, for example, the positioning transmission coils 5, 5a in the embodiments shown are arranged in the corners 57 of a quadrilateral 54 shaped as a rectangle 55, so that the frame 50 has the shape of a rectangle 55. The frame volume 51 thus has the shape of a cuboid. Due to the arrangement of the positioning transmission coils 5, 5a in the corners 57 of the rectangle 55, the particular positioning transmission coil 5, 5a is not only a longitudinal positioning transmission coil 5, 5a, 5x but also a transverse positioning transmission coil 5, 5a, 5y. With the four positioning transmission coils 5, 5a, there are thus in each case two pairs of transmission coils 5, 5a present lying opposite one another in the longitudinal direction 201 and in the transverse direction 202. Analogously, the relevant positioning field 60 is not only a longitudinal positioning field 60, 60x but also a transverse positioning field 60, 60y. Consequently, in the longitudinal direction 201, two pairs of positioning intensity maxima 61 spaced apart from one another are arranged opposite one another, and in the transverse direction 202, two pairs of positioning intensity maxima 61 spaced apart from one another are arranged opposite one another.

On the basis of the at least one determined positioning ratio 62, it is further detected whether the energy coil 3 of the induction charging device 2 having the at least one receiver 6 is located within the virtual frame volume 51. In the embodiments shown, it is therefore detected on the basis of the at least one positioning ratio 62 whether the mobile energy coil 3, 3b is located within the frame volume 51 and is thus arranged above the stationary energy coil 3, 3a in the height direction 200 and also at least partially overlaps with the stationary energy coil 3, 3a transversely to the height direction 200.

As can be seen from FIG. 12, in the embodiments shown, a virtual target region 52 is defined within the frame 50. The target region 52 is thus smaller than the frame 50. The target region 52 within the frame volume 51 defines a virtual volume 53 extending in the height direction 200, which is also referred to hereinafter as target volume 53 and is shown by dashed lines in FIG. 12. The energy coil 3 of the induction charging device 2 having the positioning transmission coils 5, i.e., the stationary energy coil 3, 3a in the embodiments shown, is arranged within the target volume 53. In FIGS. 2, 4, 7, 9 and 11, the target volume 53 is indicated by a dashed line, wherein the top view shown corresponds to the visible, dashed projection of the target area 52 in the height direction 200. The respective positioning ratio range 63 is predetermined/selected such that the energy coil 3 of the induction charging device 2 receiving the positioning fields 60 is arranged in the target volume 53.

The frame volume 51 and the target volume 53 are defined such that with a corresponding arrangement of the energy coils 3 within the frame volume 51 and within the target volume 53, a high efficiency in charging operation, for example at least 90%, is achieved. In doing so, the target volume 53 is selected such that the efficiency is greater in the case of an arrangement of both energy coils 3 within the target volume 53 than with an arrangement of both energy coils 3 within the frame volume 51. As indicated in FIG. 2, for example, the frame 50 and the target region 52 are each smaller than the associated induction charging device 2, in the embodiments shown therefore smaller than the stationary induction charging device 2, 2a.

Preferably, a positioning signal is output depending on at least one of the at least one determined ratios 62, 72, in particular depending on whether at least one of the at least one ratios 62, 72 lies in the associated ratio range 63, 73. The position signal can be used to manually move the application 100 or to autonomously move the application 100 in order to align the energy coils 3 to one another during charging operation, that is to say such that both energy coils 3 are arranged within the frame volume 51, in particular within the target volume 53. In the embodiment of the motor vehicle 101, the position signal can therefore be used to signal to a driver (not shown) whether the energy coils 3 are approaching one another and whether a desired alignment of the energy coils 3 to one another is present. For this purpose, the motor vehicle 101, as indicated in FIG. 1, can have an output apparatus 103 which outputs corresponding signals.

The detection of the overlap of the energy coils 3 within the frame volume 50, in particular within the target volume 53, is explained with the aid of FIG. 13. FIG. 13 shows the curve of two positioning fields 60, which are generated by means of two of the opposing positioning transmission coils 5, 5a. In FIG. 13, these can be purely exemplary longitudinal positioning fields 60, 60x. One of the positioning fields 60 is shown by dashed lines for better differentiation. FIG. 13 shows the intensity curve 64 of the positioning fields 60 along the longitudinal direction 201. According to FIG. 13, the positioning fields 60 of the opposing positioning transmission coils 5, 5a overlap in the target volume 53. As can be seen from FIG. 13, the positioning fields 60 have identical intensity curves 64. Thus, the positioning fields 60 shown in FIG. 5 can also be the transverse positioning fields 60, 60y, which are generated by means of two opposite transverse positioning transmission coils 5, 5a, 5y. Furthermore, in the embodiments shown, the positioning transmission coils 5, 5a are designed such and the positioning fields 60 are generated such that an overall intensity curve 66 of the positioning fields 60 generated by the positioning transmission coils 5, 5a is symmetrical between the opposite transmission coils 5, 5a and thus the intensity maxima 61 as well as symmetrical with respect to the stationary energy coil 3, 3a.

As can also be seen from FIG. 13, the relevant positioning field 60 has an intensity curve 64 with intensity flanks 65 leading to a positioning intensity maximum 61. As can further be seen from FIG. 13, the positioning intensity maxima 61 are spaced apart from one another. The positioning transmission coils 5, 5a are arranged and/or the positioning fields 60 are generated correspondingly. As can further be seen from FIG. 12, the positioning intensity maximum 61 of the respective positioning field 60 is shaped in the manner of a double hump, as already described in connection with FIG. 6. Analogously to the description of FIG. 6, this is in particular due to the fact that when positioned correspondingly the receiver 6 detects a transition of the magnetic field lines (not shown). As indicated in FIG. 13, the relevant positioning ratio range 62 is arranged between successive intensity flanks 65 of the positioning fields 60 generated by means of the opposite, associated positioning transmission coils 5, 5a and is spaced apart from the positioning intensity maxima 61. In this case, an associated longitudinal positioning ratio range 63, 63x is predetermined in advance for each of the longitudinal positioning fields 60, 60x with opposite positioning intensity maxima 61 in the longitudinal direction 201, and an associated transverse positioning ratio range 63, 63y is predetermined in advance for each of the transverse positioning fields 60, 60y with opposite positioning intensity maxima 61 in the transverse direction 202. The predetermined positioning ratio ranges 63 are preferably stored so that a simple comparison between the identified positioning ratio 62 and the associated positioning ratio range 63 can be used to detect whether an associated overlap between the energy coils 3 is present.

This means that the longitudinal positioning transmission coils 5, 5a, 5x are arranged such and the longitudinal positioning fields 60, 60x are generated such that the positioning intensity maxima 61 of two longitudinal positioning fields 60, 60x are arranged opposite one another in the longitudinal direction 201. In this case, an associated longitudinal positioning ratio range 63, 63x is predetermined in advance for at least two of the longitudinal positioning fields 60, 60x. From the longitudinal positioning fields 60, 60x received by means of the receiver 6, a longitudinal positioning ratio 62, 62x between at least two of the longitudinal positioning fields 60, 60x is identified. An overlap of the energy coils 3 within the target volume 53 in the longitudinal direction 201 will be detected if the identified longitudinal positioning ratio 62, 62x lies within the associated predetermined longitudinal positioning ratio range 63, 63x. The same applies to the overlap in the transverse direction 202. This means that the transverse positioning transmission coils 5, 5a, 5y are arranged such and/or the transverse positioning fields 60, 60y are generated such that the positioning intensity maxima 61 of two transverse positioning fields 60, 60y are arranged opposite one another in the transverse direction 202. Further, an associated transverse positioning ratio range 63, 63y is predetermined in advance for at least two of the transverse positioning fields 60, 60y. In positioning operation, a transverse positioning ratio 62, 62y between at least two of the transverse positioning fields 60, 60y is identified from transverse positioning fields 60, 60y received by the receiver 6. In this case, an overlap 3 of the energy coils 3 within the target volume 53 in the transverse direction 202 will be detected if the identified transverse positioning ratio 62, 62y lies within the associated predetermined transverse positioning ratio range 63, 63y. An overlap of the energy coils 3 in the longitudinal direction 201 and in the transverse direction 202 therefore occurs when at least one of the longitudinal positioning ratios 62, 62x lies within the longitudinal positioning ratio range 63, 63x and at least one of the transverse positioning ratios 62, 62y lies within the transverse positioning ratio range 63, 63y.

For example, for an overlap within the frame volume 51, a positioning ratio range 63 between 10:0.05 and 0.05:10 can be given, and for an overlap within the target volume 53, a positioning ratio range 63 between 1:0.1 and 0.1:1 can be given.

Advantageously, the positioning ratio 62 of both positioning fields 60 having the opposite positioning intensity maxima 61 is determined and, if the positioning ratios 62 deviate, the positioning ratio 62 of the positioning fields 60 with the lower intensity is used to detect the relative position. As a result, those positioning fields 60 are used, the identified positioning ratio 62 of which is further spaced apart from the positioning intensity maxima 61. This prevents in particular the double-hump shape of the positioning intensity maxima 61 described above from leading to a false detection of the position. If, on the other hand, the two positioning ratios 62 substantially correspond to one another, i.e., if the positioning ratios 62 are substantially the same or fall within a predetermined mean range, the two positioning ratios 62 will be averaged to detect the relative position.

If the identified positioning ratio 62 deviates from the associated positioning ratio range 63 towards a positioning intensity maximum 61 of one of the associated positioning fields 60, an offset of the energy coil 3 of the receiving induction charging device 2, which thus has the receiver 6, towards that positioning intensity maximum 61 and thus towards the transmission coil 5 generating the positioning intensity maximum 61, towards which the positioning ratio 62 is shifted, will also be detected. In other words, if the identified longitudinal positioning ratio 62, 62x is shifted from the associated longitudinal positioning ratio range 63, 63x to one of the positioning intensity maxima 61 of one of the associated longitudinal positioning fields 60, 60x, this means that there is an offset of the mobile energy coil 3, 3b from the target volume 53 along the longitudinal direction 201 to that longitudinal positioning transmission coil 5, 5a, 5x which generates the longitudinal positioning field 60, 60x with that positioning intensity maximum 61 to which the identified longitudinal positioning ratio 62, 62x is shifted. The same applies to the identified transverse positioning ratio 62, 62y. In other words, if the identified transverse positioning ratio 62, 62y is shifted from the associated transverse positioning ratio range 63, 63y to one of the positioning intensity maxima 61 of one of the associated transverse positioning fields 60, 60y, this means that there is an offset of the mobile energy coil 3, 3b from the target volume 53 along the transverse direction 202 to that transverse positioning transmission coil 5, 5a, 5y which generates the transverse positioning field 60, 60y with that positioning intensity maximum 61 to which the identified transverse positioning ratio 62, 62y is shifted. A navigation of the mobile induction charging device 2, 2a can thus be realized in such a way that an overlap of the two energy coils 3 in the target volume and thus not only in the longitudinal direction 201 but also in the transverse direction 202 is achieved. This can, analogously to the approach and as indicated in FIG. 1, be effected by means of the output apparatus 103 in order to output whether and in which direction a relative movement of the mobile induction charging device 2, 2b to the stationary induction charging device 2, 2a is necessary in order to achieve an overlap of the energy coils 3 in the longitudinal direction 201 and in the transverse direction 202. In the embodiment shown in FIG. 1, this is effected purely visually by means of the display of arrows indicated in FIG. 1. It is also conceivable for the output apparatus 103 to output an acoustic signal. It is also conceivable to implement the result autonomously, so that the motor vehicle 101 is driven autonomously in order to achieve an overlap of the energy coils 3.

A maximized efficiency in charging operation is achieved with a corresponding position of the energy coils 3 relative to one another, which is also referred to hereinafter as a centered arrangement. The centered arrangement is in each case assigned a positioning ratio 63 within the positioning ratio ranges 63. This means that with a predetermined centering longitudinal positioning ratio in the longitudinal positioning ratio range 63, 63x, there is a mutually centered arrangement of the energy coils 3 in the longitudinal direction 201. In addition, with a predetermined centering transverse positioning ratio in the transverse positioning ratio range 63, 63y, there is a mutually centered arrangement of the energy coils 3 in the transverse direction 202. An overall centered arrangement is thus present if at least one of the identified longitudinal positioning ratios 62, 62x corresponds to the associated centering longitudinal positioning ratio and at least one of the identified transverse positioning ratios 62, 62y corresponds to the associated centering transverse positioning ratios. The relevant centering positioning ratio in the embodiments shown is 1:1, as indicated in FIG. 13. Analogous to the above explanation, it is possible to implement navigation in such a way that an overall centered arrangement of the energy coils 3 is present.

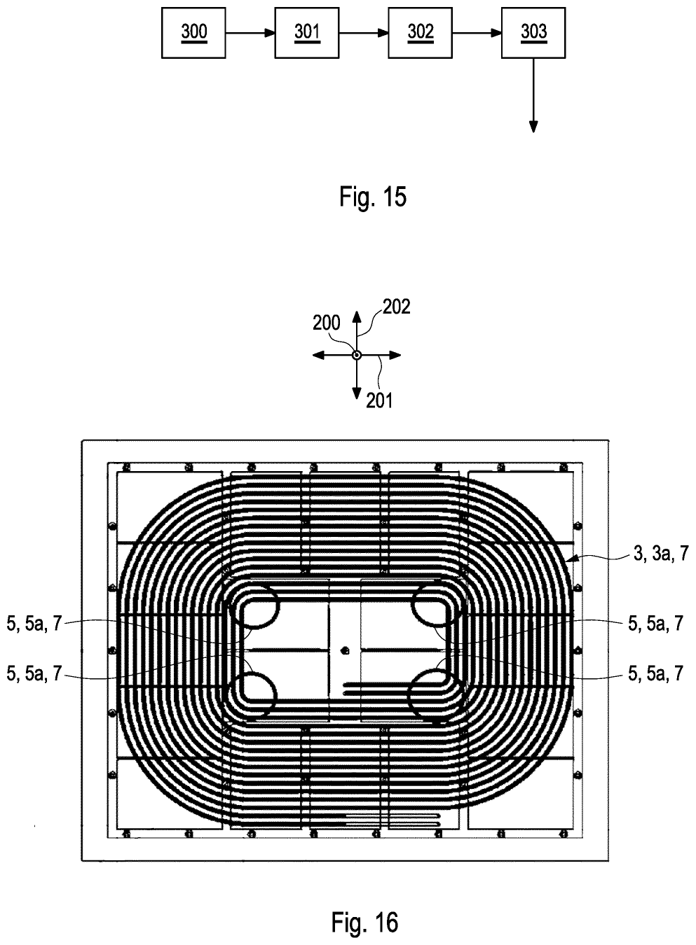

FIG. 15 shows a flow chart to explain the detection of the position of the energy coils 3 relative to one another. The approach operation, preferably also the positioning operation is initiated when the application 100 and thus the mobile induction charging device 2, 2b approaches the stationary induction charging device 2, 2a. This is the case, for example, when a distance between the induction charging devices 2 transversely to the height direction 200 is less than 10 m. The approach operation can be initiated, for example, by means of a ping signal (not shown) emitted by the mobile induction charging device 2, 2b, upon receipt of which the mobile induction charging device 2, 2a generates the fields 60, 70 with the transmission coils 5. According to FIG. 15, in a method step 300, which is also referred to hereinafter as reception step 300, the fields 60 are received by the receiver 6 and separated from one another in a subsequent method step 301 such that the fields 60, 70, in particular their intensities, can be distinguished from one another. In the method step 301, in particular a Fourier transform of the signals received by means of the receiver 6 is carried out, in the case of a receiver coil 15 i.e. of the voltages induced in the receiver coil 6 with the fields 60, 70. The method step 301 is also referred to hereinafter as separation step 301. The result of the separation step 301 is thus an associated value for the respective at least one approach field 70 as well as for the respective positioning field 60. From these values, in a method step 302, a value of the intensity of the received approach field 70 is thus determined in the method step 302 for the embodiment shown in FIGS. 2 and 3. If such a value is detected or determined, an approach of the energy coils 3 is detected. Furthermore, in the method step 302, the approach ratios 72 associated with the successive or opposite approach intensity maxima 71 are determined for approach fields 70. In addition, in the method step 302, the associated longitudinal positioning ratios 62, 62x and transverse positioning ratios 62, 62y are determined for the longitudinal positioning fields 60, 60x and the transverse positioning fields 60, 60y. It is advantageous to average several values, for example the last ten values identified, in order to increase the accuracy of the method and/or reduce the susceptibility to errors. The method step 302 is also referred to hereinafter as positioning ratio step 302. The ratios 62, 72 determined in the positioning ratio step 102 are compared in a method step 303 with the corresponding previously predetermined ratio ranges 63, 73 and, based on the comparison, it is determined whether a corresponding approach or a corresponding overlap of the energy coils 3 exists. The method step 303 is also referred to hereinafter as comparison step 303. The comparison step 303 outputs at least one position signal, as indicated in FIG. 15. The position signal is preferably used, as explained above, for the navigation of the mobile application 100. Accordingly, the position signals can be made available to the output apparatus 103.

To carry out the detection of the relative position, a correspondingly designed control apparatus 16, shown in simplified form in FIG. 1, can be used. The control apparatus 16 can be a constituent part of the positioning device 4, of the system 1 or of the application 100. The method can be carried out by means of a computer program product.

According to FIG. 12, the induction charging device 2 having the positioning transmission coils 5, 5a in the present case that is to say the stationary induction charging device 2, 2a, has in the embodiments shown a flat coil 7 as the energy coil 3, which flat coil is larger than the positioning transmission coils 5, 5a. In addition, the stationary induction charging device 2, 2a has a magnetic flux guide unit 8 for guiding the alternating field generated by the stationary energy coil 3, 3a during charging operation. For this purpose, the magnetic flux guide unit 8 in the embodiment shown has magnetic flux guide elements 9 which are designed as ferrite plates 10. The positioning transmission coils 5, 5a overlap the stationary energy coil 3, 3a and are arranged in corners 57 of a rectangle 55 (see for comparison, for example, FIG. 12) and in a plane running parallel to the stationary energy coil 3, 3a. Furthermore, the positioning transmission coils 5, 5a are arranged above the magnetic flux guide unit 9.

FIG. 13 shows possible relative positions of the positioning transmission coils 5, 5a in relation to the stationary energy coil 3, 3a. Accordingly, the positioning transmission coils 5, 5a can be arranged in the height direction 200 between the stationary energy coil 3, 3a and the magnetic flux guide unit 8, on the side of the magnetic flux guide unit 8 facing away from the stationary energy coil 3, 3a or on the side of a foreign object detection apparatus 17 of the stationary induction charging device 2, 2a facing the stationary energy coil 3, 3a.

FIG. 16 shows a further embodiment which differs from the preceding embodiments in that the positioning transmission coils 5, 5a are arranged offset inwardly.

1. A method for detecting the relative position of a stationary induction charging device to a mobile induction charging device, the stationary induction charging device including a stationary energy coil and the mobile induction charging device including a mobile energy coil, wherein during a charging operation, one of the stationary energy coil and the mobile energy coil provides an alternating magnetic field which induces a voltage for energy transfer in the other of the stationary energy coil and the mobile energy coil, and wherein the stationary energy coil and the mobile energy coil, during the charging operation, are disposed spaced apart from one another in a height direction and overlap transversely to the height direction, the method comprising:
providing, in one of the stationary induction charging device and the mobile induction charging device, at least two distinguishable fields each having an intensity maximum, the at least two fields each provided fixedly relative to the energy coil of the associated induction charging devices;
at least one of the at least two fields provided as an approach field having an approach intensity maximum spaced transversely to the height direction from the energy coil of the associated induction charging device;
receiving the at least two fields in the other induction charging device;
wherein, for the approach field and at least one further field of the at least two fields, an approach ratio range is predetermined in advance for which the stationary energy coil and the mobile energy coil approach transversely to the height direction;
determining an approach ratio between the received approach field and the at least one received further field; and
detecting that the mobile energy coil approaches the stationary energy coil transversely to the height direction when the determined approach ratio lies in the approach ratio range.

2. The method according to claim 1, wherein:
providing the at least two fields includes providing at least two distinguishable approach fields, which each have an associated approach intensity maximum, such that the approach intensity maxima of the at least two approach fields to the energy coil of the associated induction charging device follow one another in a distance direction extending transversely to the height direction;
for the at least two approach fields with the approach intensity maxima following one another in the distance direction, a second approach ratio range is predetermined in advance for which the mobile energy coil approaches the stationary energy coil in the distance direction; and
the method further comprises:
determining a second approach ratio between the at least two received approach fields; and
detecting that the mobile energy coil approaches the stationary energy coil in the distance direction when the determined second approach ratio lies in the second approach ratio range.

3. The method according to claim 2, wherein:
the at least two approach fields includes at least three approach fields; and
the method further comprises:
determining a plurality of approach ratios between at least two of the received at least three approach fields; and
detecting that the mobile energy coil approaches the stationary energy coil in the distance direction when the plurality of approach ratios are determined in an order of a distance of the associated approach intensity maximum in the distance direction to the stationary energy coil.

4. The method according to claim 1, wherein:
providing the at least two fields includes providing at least two distinguishable approach fields, which each have an associated approach intensity maximum, such that the approach intensity maxima of the at least two approach fields are spaced from the energy coil of the associated induction charging device and are arranged opposite one another in an overlap direction;
for the at least two approach fields having the approach intensity maxima opposite one another in the overlap direction, a second approach ratio range is predetermined in advance for which the mobile energy coil overlaps with the stationary energy coil along the overlap direction and is spaced from the stationary energy coil in a distance direction extending transversely to the overlap direction; and
the method further comprises:
determining a second approach ratio between the at least two received approach fields; and
detecting that the mobile energy coil approaches the stationary energy coil in the distance direction and overlaps with the stationary energy coil in the overlap direction when the determined second approach ratio lies in the second approach ratio range.

5. The method according to claim 4, wherein:
the at least two approach fields are provided such that the overlap direction corresponds to a transverse direction extending transversely to the height direction; and
the second approach ratio range is predetermined in advance such that the distance direction corresponds to a longitudinal direction extending transversely to the height direction and transversely to the transverse direction.

6. The method according to claim 4, wherein:
the at least two approach fields includes at least four distinguishable approach fields each having an associated approach intensity maximum, the at least four approach fields provided such that in each case a pair of the approach intensity maxima is arranged opposite one another parallel to the overlap direction and the pairs are spaced apart from one another in the distance direction;
for a respective pair, an associated third approach ratio range is predetermined in advance; and
the method further comprises detecting that the mobile energy coil approaches the stationary energy coil in the distance direction and overlaps with the stationary energy coil in the overlap direction when a plurality of third approach ratios of the pairs are determined in an order of a respective distance in the distance direction to the stationary energy coil.

7. The method according to claim 1, wherein:
providing the at least two fields includes providing the approach field and at least two positioning fields such that:
the at least two positioning fields are distinguishable from one another and from the approach field, and such that the energy coil of the associated induction charging device is fixedly positioned relative to the at least two positioning fields; and
the energy coil of the associated induction charging device is disposed at least partially in a virtual frame volume delimited by at least two positioning intensity maxima of the at least two positioning fields and extending in the height direction, which is spaced from the approach intensity maximum of the approach field;
for the approach field and at least one positioning field of the at least two positioning fields, a second approach ratio range is predetermined in advance for which the mobile energy coil approaches the stationary energy coil; and
the method further comprises:
determining a second approach ratio between the received approach field and the at least received positioning field; and
detecting that the mobile energy coil is approaching the stationary energy coil when the determined second approach ratio lies in the second approach ratio range.

8. The method according to claim 7, wherein:
a positioning ratio range of the at least two received positioning fields is predetermined in advance for which the energy coil of the induction charging device receiving the at least two positioning fields is arranged in the virtual frame volume; and
the method further comprises:
determining a positioning ratio between the at least two received positioning fields; and
detecting that the stationary energy coil and the mobile energy coil are arranged in the virtual frame volume and overlap transversely to the height direction when the determined positioning ratio lies within the predetermined positioning ratio range.

9. The method according to claim 8, wherein:
within the virtual frame volume, a virtual target volume extending in the height direction is defined such that the energy coil of the induction charging device providing the at least two positioning fields lies at least partially in the virtual target volume; and
the positioning ratio range is predetermined such that the energy coil of the induction charging device receiving the at least two positioning fields is arranged in the virtual target volume.

10. The method according to claim 8, wherein:
providing the at least two positioning fields includes providing a plurality of positioning fields each having an associated positioning intensity maximum, the plurality of positioning fields including at least two longitudinal positioning fields and at least two transverse positioning fields;
the positioning intensity maxima of the at least two longitudinal positioning fields are arranged opposite one another in a longitudinal direction extending transversely to the height direction;
an associated longitudinal positioning ratio range is predetermined in advance for the at least two longitudinal positioning fields;
the positioning intensity maxima of the at least two transverse positioning fields are arranged opposite one another in a transverse direction extending transversely to the height direction;
an associated transverse positioning ratio range is predetermined in advance for the at least two transverse positioning fields; and
the method further comprises:
determining a longitudinal positioning ratio between the at least two longitudinal positioning fields from the received plurality of positioning fields:
determining a transverse positioning ratio between the at least two transverse positioning fields from the received plurality of positioning fields;
detecting that the stationary energy coil and the mobile energy coil overlap in the virtual frame volume in the longitudinal direction when the determined longitudinal positioning ratio is within the associated predetermined longitudinal positioning ratio range; and
detecting that the stationary energy coil and the mobile energy coil in the virtual frame volume overlap in the transverse direction when the determined transverse positioning ratio is within the associated predetermined transverse positioning ratio range.

11. The method according to claim 10, wherein the plurality of positioning fields are provided such that at least one of:
in the longitudinal direction two pairs of positioning intensity maxima spaced apart from one another are arranged opposite one another; and
in the transverse direction, two pairs of positioning intensity maxima spaced apart from one another are arranged opposite one another.

12. The method according to claim 1, further comprising, when the determined approach ratio deviates from the approach ratio range towards an intensity maximum of one of the associated fields, detecting an offset of the stationary energy coil and the mobile energy coil towards the intensity maximum towards which the determined approach ratio is offset.

13. The method according to claim 1, further comprising outputting a position signal depending on a determined value of the determined approach ratio to the approach ratio range.

14. The method according to claim 10, wherein the plurality of positioning fields are provided such that at least one of:
at a predetermined centering longitudinal positioning ratio in the longitudinal positioning ratio range, there is a centered arrangement of the stationary energy coil and the mobile energy coil in the longitudinal direction; and
at a predetermined centering transverse positioning ratio in the transverse positioning ratio range, there is a mutually centered arrangement of the stationary energy coil and the mobile energy coil in the transverse direction.

15. The method according to claim 1, wherein the at least two fields are provided such that the approach ratio range is spaced from the intensity maxima of the associated fields.

16. The method according to claim 1, wherein the at least two fields are magnetic fields.

17. The method according to claim 1, wherein the at least two fields have identical intensity curves.

18. The method according to claim 1, wherein the at least two fields have different frequencies such that the at least two fields are distinguishable.

19. The method according to claim 1, wherein the at least two fields have respective duty cycles such that the at least two fields are distinguishable.

20. The method according to claim 1, wherein at least one of the at least two fields has a main axis extending along the height direction.

21. A computer program product configured to execute the method according to claim 1.

22. A system, comprising a stationary induction charging device, a mobile application including a mobile induction charging device, and a control apparatus, wherein:
the stationary induction charging device includes a stationary energy coil;
the mobile induction charging device includes a mobile energy coil;
the stationary energy coil and the mobile energy coil are spaced apart from one another in a height direction during a charging operation and interact inductively to inductively transfer energy to the mobile application;
one of the stationary induction charging device and the mobile induction charging device further includes at least two transmission coils that provide at least two fields during operation;
the other of the stationary induction charging device and the mobile induction charging device further includes at least one receiver for receiving the at least two fields; and
the control apparatus is configured to operate the system according to the method of claim 1.

23. A mobile application, comprising a mobile induction charging device of the system according to claim 22.

24. A stationary induction charging device of the system according to claim 22.
